(19) United States
(12) Patent Application Publication
(10) Pub. No.: US 2015/0139164 A1
(43) Pub. Date: May 21, 2015

(54) BASE STATION APPARATUS, MOBILE STATION APPARATUS, COMMUNICATION SYSTEM, AND COMMUNICATION METHOD

(71) Applicant: FUJITSU LIMITED, Kawasaki-shi (JP)

(72) Inventors: Tetsuya YANO, Yokohama (JP); YOSHIHIRO KAWASAKI, Kawasaki (JP)

(21) Appl. No.: 14/608,924

(22) Filed: Jan. 29, 2015

Related U.S. Application Data
(63) Continuation of application No. PCT/JP2012/070505, filed on Aug. 10, 2012.

(51) Int. Cl. H04W 72/04; H04L 5/14; H04L 5/00

(52) U.S. Cl. CPC H04W 72/0406; H04L 5/0053; H04L 5/0091; H04L 5/14
USPC 370/329

(57) ABSTRACT

A communication apparatus provided with a selector that selects a subframe, which transmits a signal to a first communication apparatus from a second communication apparatus by a first carrier, as a subframe for transmitting data from the first communication apparatus to the second communication apparatus by a second carrier, from among a plurality of subframes which form wireless frames and are respectively allocated in any transmission directions of time-division duplex; a joint coder that jointly codes indication information for indicating the subframe selected by the selector with control information transmitted by the first carrier to generate a code; and a code transmitter that transmits the code generated by the joint coder to the second communication apparatus by the first carrier.

### CROSS-REFERENCE TO RELATED APPLICATION

This application is a continuation application of International Application PCT/JP 2012/070505, filed on Aug. 10, 2012, the entire contents of which are incorporated herein by reference.

### FIELD

The embodiments which are discussed in the present specification relate to a base station apparatus, mobile station apparatus, communication system, and communication method.

### BACKGROUND

In mobile communications, it is known to make a single mobile station apparatus send and receive a plurality of carriers in parallel. As one example of such art, there is “carrier aggregation”. Further, in TDD (Time Division Duplexing), it is known to allocate each subframe obtained by dividing a wireless frame for an uplink (UL) or a downlink (DL). As one example of such allocation, there is the “UL-DL configuration” (uplink-downlink configuration) which is defined in the 3GPP (3^{rd} Generation Partnership Project) TS (Technical Specification) 36.211.

As related art, it is known to issue an HARQ (Hybrid Automatic Repeat reQuest) in a wireless communication system which is carried out by a terminal. In this method, a first subframe receives a downlink allocation. The downlink allocation is transmitted based on a logically indexed resource unit called a CCE (Control Channel Element). The first subframe receives downlink data on a downlink shared channel. The downlink shared channel is allocated by downlink allocation. An ACK/NACK signal which indicates successful or unsuccessful reception of downlink data is generated. The uplink resource of a second subframe is utilized to transmit an ACK/NACK signal or a representative ACK/NACK signal.

As related art, a method of data reception which is used by a terminal in a wireless communication system is known. This method includes a step of receiving downlink scheduling information from a base station through a first downlink component carrier on a physical downlink control channel (PDCCH). This method includes a step of using the downlink scheduling information as the basis to receive data from the base station through a second downlink component carrier. The PDCCH and PDSCH (Physical Downlink Shared CHannel) are transmitted at the same subframe.

As related art, the method is known of having a base station apparatus use a CIF (Carrier Indicator Field) to notify a CC (Component Carrier) and/or a subframe to which a PDSCH is allocated.

### RELATED ART LIST

### Patent Literature

PLT 1: Japanese Laid-Open Patent Publication No. 2011-517168
PLT 2: Japanese Laid-Open Patent Publication No. 2011-529661
PLT 3: Japanese Laid-Open Patent Publication No. 2012-5074

### Nonpatent Literature

NPLT 1: 3GPP TS 36.211 V10.5.0
NPLT 2: 3GPP TS 36.212 V10.6.0
NPLT 3: 3GPP TS 36.213 V10.6.0

When the subframes which are allocated to the downlink differ among the plurality of carriers by which a mobile station apparatus sends and receives signals in parallel, sometimes a subframe which is allocated to the uplink at one carrier may be allocated to the downlink at another carrier. In this case, if that one carrier tries to send downlink scheduling information for other data, it will not be possible to send the radio resource allocation information of this data by the same subframe as the subframe by which data is transmitted.

If adding indication information of the subframe by which data is transmitted to the downlink control information, this will invite an increase in the downlink control information.

### SUMMARY

According to one aspect of an apparatus, there is provided a first communication apparatus. The first communication apparatus (2) is provided with a selector (10) that selects a subframe, which transmits a signal to a first communication apparatus (2) from a second communication apparatus (3) via a first carrier, from among a plurality of subframes which form wireless frames and which are respectively allocated in any transmission directions of time-division duplex, as a subframe for transmitting data from the first communication apparatus (2) to the second communication apparatus (3) via a second carrier. The first communication apparatus (2) is provided with a joint coder (11) that jointly codes indication information for indicating the subframe selected by the selector (10) with control information transmitted by the first carrier, or that allocates, to a bit string, combinations of the indication information of the subframe which was selected by the selector (10) and control information which was transmitted by the first carrier, so as to obtain a code, and with a code transmitting unit (12, 17, 18) that transmits the code generated by the joint coder (11) by the first carrier to the second communication apparatus.

According to another aspect of an apparatus, there is provided a second communication apparatus. The communication apparatus is provided with a code receiver that receives a code in a subframe, which transmits a signal from a first apparatus to a second apparatus via a first carrier, from among a plurality of subframes which form wireless frames and which are respectively allocated in any transmission directions of time-division duplex, the code received being obtained by jointly coding control information with indication information for indicating any subframe in which a signal to the first apparatus is transmitted from the second communication apparatus via the first carrier, or by allocating, to a bit string, combinations of the indication information of the subframe and control information which is transmitted by the first carrier. The second communication apparatus is further provided with a data receiver that receives data which is transmitted from the first communication apparatus by the second carrier by the subframe indicated by the indication information.

According to one aspect of a method, there is provided a communication method. The communication method comprises selecting a subframe, which is transmitted to a first communication apparatus from a second communication apparatus via a first carrier, from among a plurality of subframes which form wireless frames and which are respectively allocated in any transmission directions of time-division duplex, as a subframe for transmitting data from the first communication apparatus to the second communication apparatus via a second carrier. The communication method further comprises jointly coding indication information for indicating the subframe selected with control information transmitted by the first carrier or allocating, to a bit string, combinations of the indication information of the subframe selected and control information transmitted by the first carrier, to generate a code, and transmitting the code by the first carrier to the second communication apparatus.

The object and advantages of the invention will be realized and attained by means of the elements and combinations particularly pointed out in the appended claims. Both the above-mentioned general description and the following detailed description are mere illustrations and explanations and should be understood as not limiting the invention in a manner like the claims.

### BRIEF DESCRIPTION OF DRAWINGS

FIG. 1 is a view which explains an example of the configuration of a communication system.

FIG. 2 is a view which explains UL-DL configurations.

FIG. 3 is a view which explains one example of UL-DL configurations of a scheduling cell and a scheduled cell.

FIG. 4 is a view of a functional configuration of an example of a base station apparatus.

FIGS. 5A and 5B are views which explain examples of allocation information.

FIG. 6 is a view which explains one example of UL-DL configurations of a scheduling cell and a scheduled cell.

FIG. 7 is a view of a functional configuration of an example of a mobile station apparatus.

FIG. 8 is a view which explains one example of operation of a base station apparatus.

FIG. 9 is a view which explains one example of operation of a mobile station apparatus.

FIG. 10 is a view which explains one example of UL-DL configurations of a scheduling cell and a scheduled cell.

FIG. 11 is a view which explains one example of allocation information.

FIG. 12 is a view which explains examples of selection of subframes.

FIG. 13 is a view which explains one example of allocation information.

FIG. 14 is a view which explains one example of allocation information.

FIG. 15 is a view which explains one example of allocation information.

FIG. 16 is a view which explains one example of UL-DL configurations of a scheduling cell and a scheduled cell.

FIG. 17 is a view which explains one example of allocation information.

FIG. 18 is a view which explains one example of allocation information.

FIG. 19 is a table which illustrates combinations of UL-DL configurations for which setting of allocation information is considered in a second embodiment.

FIG. 20 is a view which explains one example of UL-DL configurations of a scheduling cell and a scheduled cell.

FIG. 21 is a view which explains one example of allocation information.

FIG. 22 is a view which explains one example of UL-DL configurations of a scheduling cell and a scheduled cell.

FIG. 23 is a view which explains one example of allocation information.

FIGS. 24A and 24B are views which explain examples of UL-DL configurations of a scheduling cell and a scheduled cell.

FIG. 25 is a view which explains one example of UL-DL configurations of a scheduling cell and a scheduled cell.

FIG. 26 is a view which explains one example of allocation information.

FIGS. 27A and 27B are views which explain examples of UL-DL configurations of a scheduling cell and scheduled cell.

FIGS. 28A and 28B are views which explain examples of UL-DL configurations of a scheduling cell and scheduled cell.

FIGS. 29A and 29B are views which explain examples of UL-DL configurations of a scheduling cell and scheduled cell.

FIGS. 30A and 30B are views which explain examples of UL-DL configurations of a scheduling cell and scheduled cell.

FIG. 31 is a view which explains one example of UL-DL configurations of a scheduling cell and a scheduled cell.

FIG. 32 is a view which explains a maximum number of a number of HARQ processes.

FIG. 33 is a view which explains one example of allocation information.

FIG. 34 is a view which explains one example of allocation information.

FIG. 35 is a view which explains one example of allocation information.

FIG. 36 is a view which explains one example of allocation information.

FIG. 37 is a view which explains one example of allocation information.

FIG. 38 is a view which explains one example of allocation information.

FIG. 39 is a view which explains one example of a hardware configuration of a base station apparatus.

FIG. 40 is a view which explains one example of a hardware configuration of a mobile station apparatus.

### DESCRIPTION OF EMBODIMENTS

According to the apparatuses and method which are disclosed in this specification, the increase in downlink control information, which occurs when the subframes allocated to a downlink differ among a plurality of carriers by which a mobile station apparatus sends and receives signals in parallel, is reduced.

### 1. First Embodiment

### 1.1. Example of Configuration of Communication System

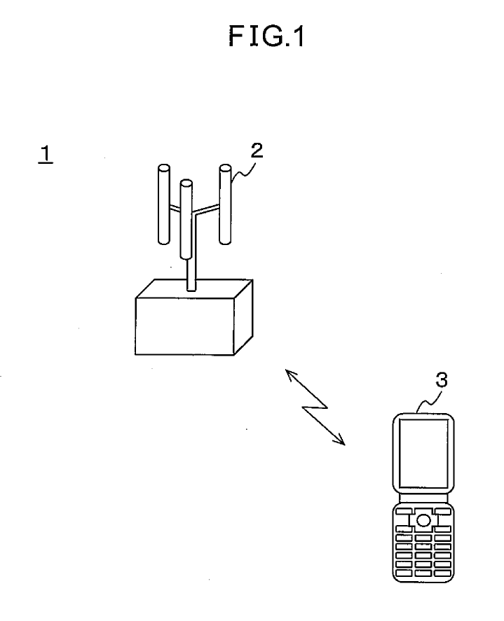

Below, referring to the attached drawings, a preferable embodiment will be explained. FIG. 1 is a view which explains an example of the configuration of a communication system. The communication system 1 is provided with a first communication apparatus 2 and a second communication apparatus 3. One example of the first communication apparatus 2 is a base station apparatus. Further, one example of the second communication apparatus 3 is a mobile station apparatus. In the following explanation, the example of the case where the first communication apparatus 2 and the second communication apparatus 3 are a base station apparatus and a mobile station apparatus based on the LTE (Long Term Evolution)-Advanced for which standards are being established at the 3GPP, will be used. However, this example does not mean that the communication apparatuses which are described in this specification apply to only to a communication system based on LTE-Advanced. The communication apparatuses, which are described in this specification, can be widely applied to a communication system where a single communication apparatus sends and receives a plurality of carriers in parallel and where the carrier for transmission of downlink data or a process number, which indicates a process in an automatic repeat request, is transmitted as control information.

The base station apparatus 2 is a wireless communication apparatus which wirelessly connects with a mobile station apparatus 3 to engage in wireless communication. Further, the base station apparatus 2 can provide various services such as voice communication or video distribution to the mobile station apparatus in the range of one or more cells. In the following explanation and attached drawings, the base station apparatus and the mobile station apparatus will sometimes respectively be called the “base station” and the “mobile station”.

The mobile station 3 is a wireless communication apparatus which wirelessly connects with the base station 2 to engage in wireless communication. The mobile station 3 may, for example, be a mobile phone or mobile information terminal device etc. The mobile station 3 can receive a data signal etc. from the base station 2 and send a data signal etc. to the base station 2. In this specification, a communication link from the base station 2 to the mobile station 3 will sometimes be called a “downlink” (DL), while a communication link from the mobile station 3 to the base station 2 will sometimes be called an “uplink” (UL).

In the communication system 1, the base station 2 and the mobile station 3 can use a plurality of component carriers, which respectively form a plurality of cells, to send and receive signals by a plurality of physical channels simultaneously and in parallel. A cell by which a PDCCH signal is transmitted to the mobile station 3 is called a “scheduling cell”. Further, a cell by which a PDSCH signal is transmitted to the mobile station 3 is called a “scheduled cell”. Further, a component carrier is called a “CC”. A CC falls under one of the frequency bands. The allocation of subframes to the uplink and downlink is determined by the UL-DL configuration for each frequency band or each CC, according to the UL-DL configurations.

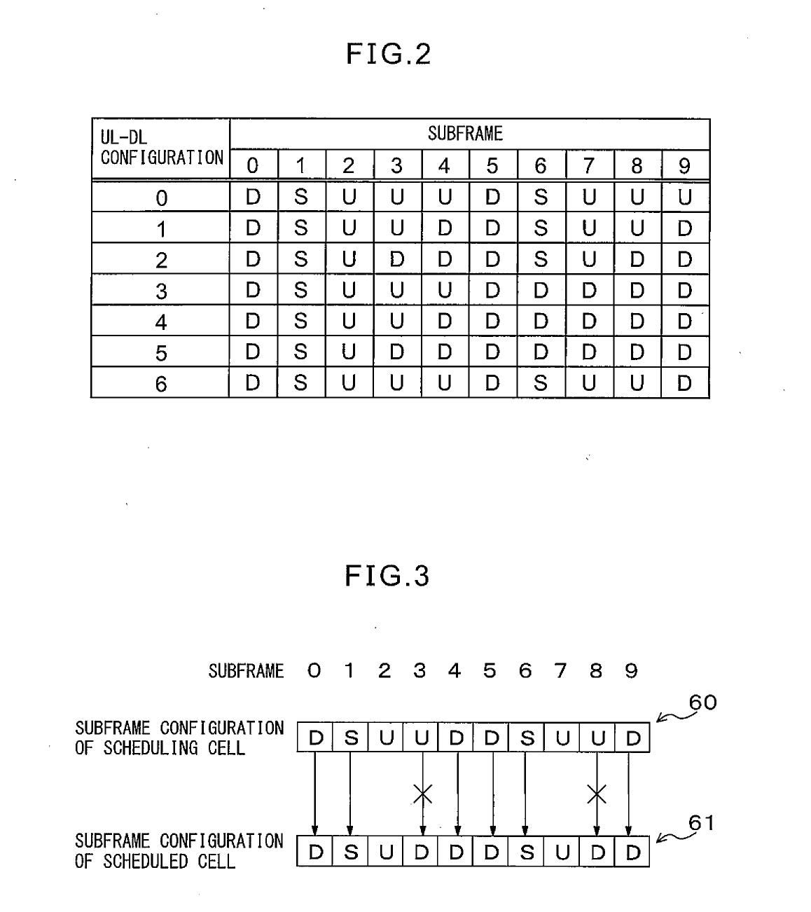

FIG. 2 is a view which explains UL-DL configurations. In FIG. 2, “D” indicates a subframe which is allocated to the downlink, “U” indicates a subframe which is allocated to the uplink, and “S” indicates a special subframe. Special subframes are used for frame synchronization or downlink transmission or uplink transmission. For example, in a cell of a band where the UL-DL configuration is “0”, the subframes 0 and 5 are allocated to the downlink, the subframes 2 to 4 and 7 to 9 are allocated to the uplink, and the special subframes are the subframes 1 and 6.

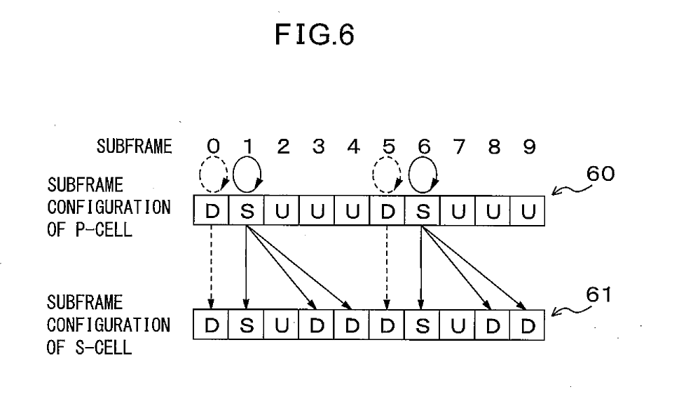

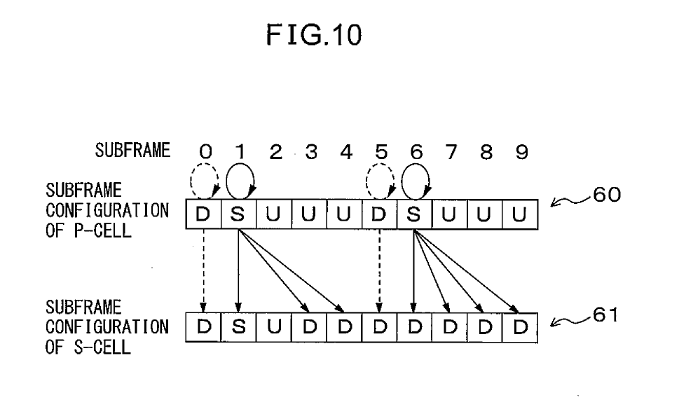

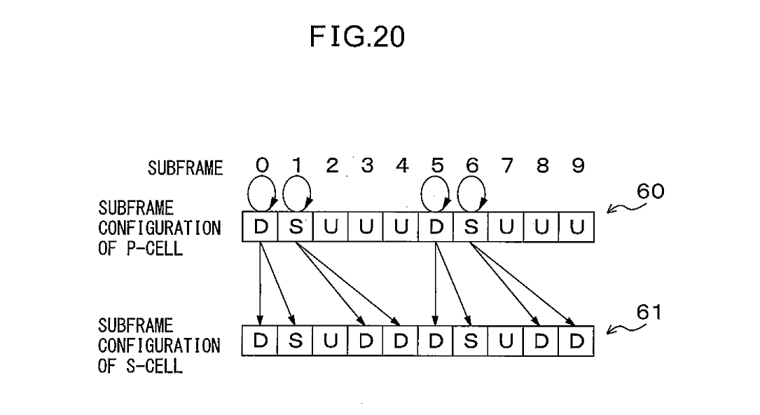

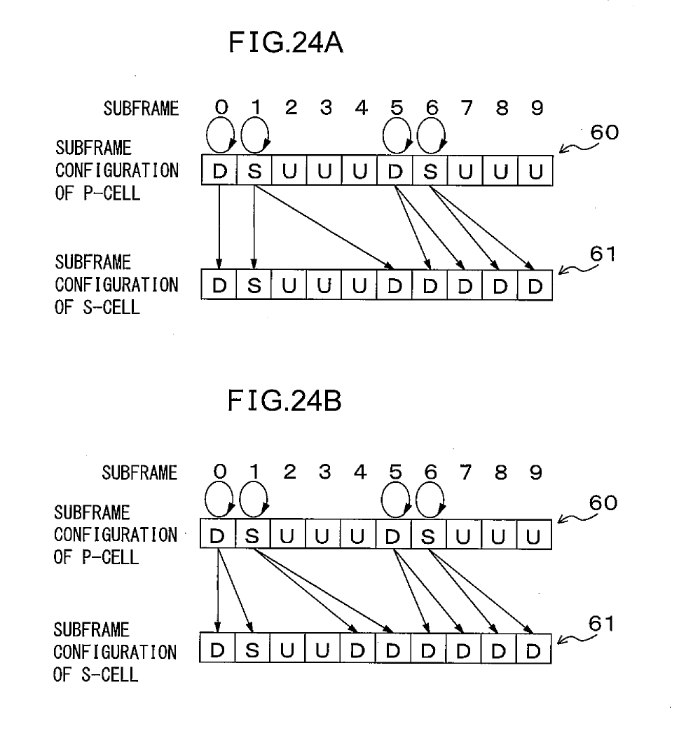

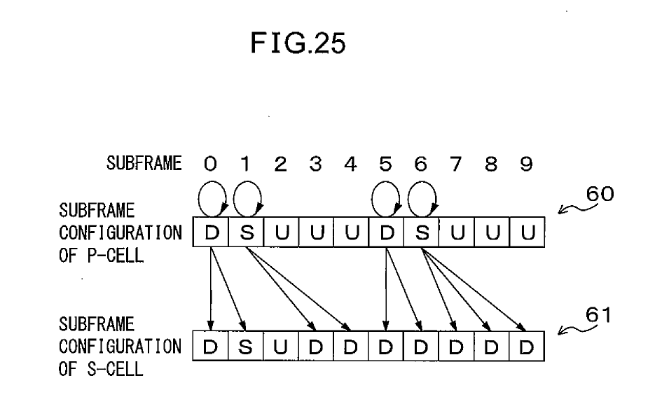

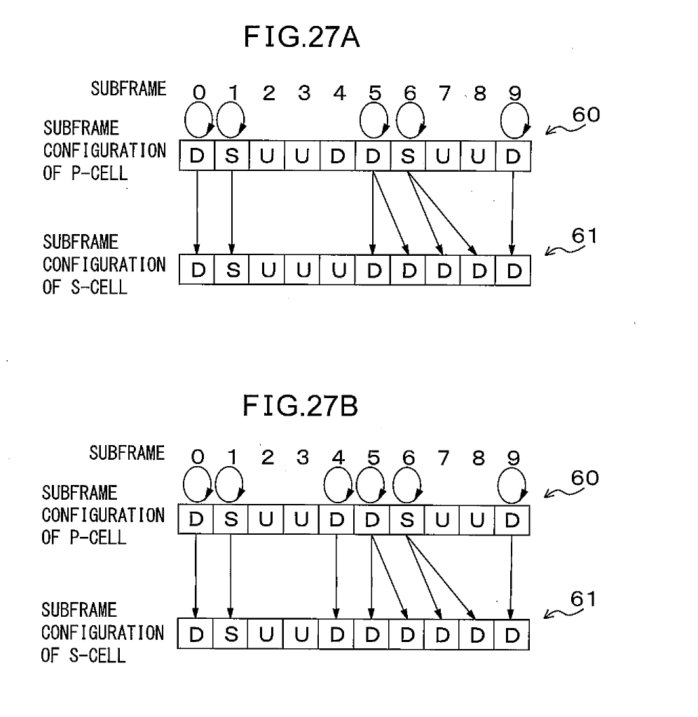

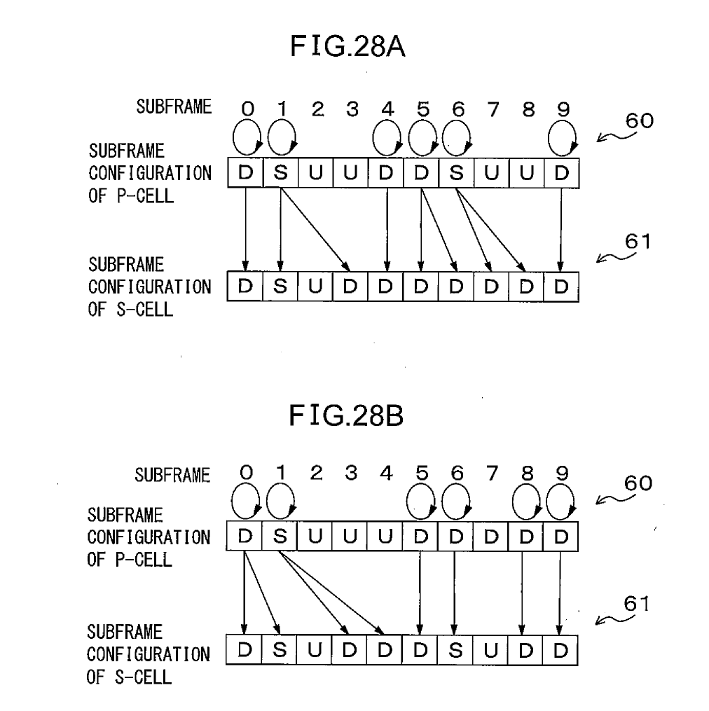

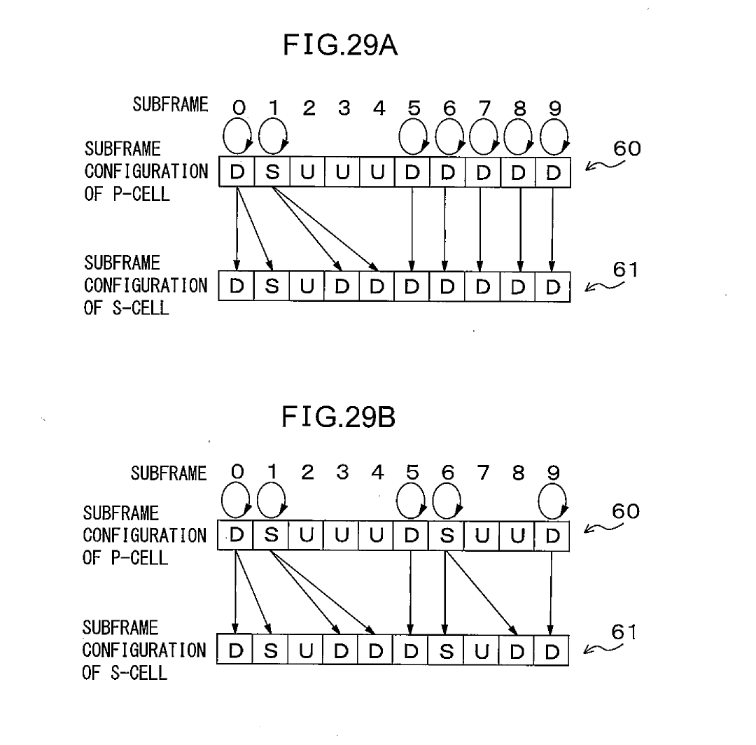

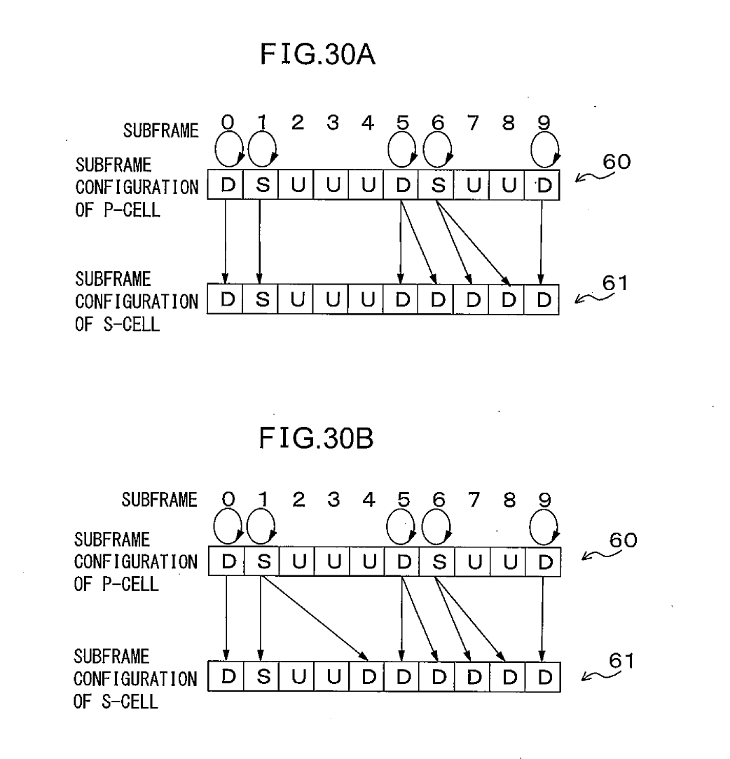

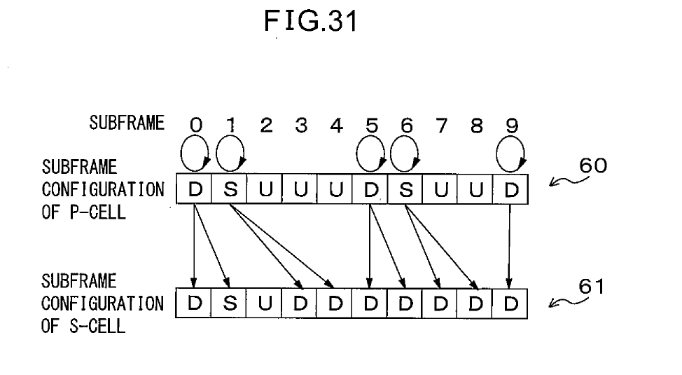

When a scheduling cell and a scheduled cell belong to different frequency bands, a situation can arise where the UL-DL configurations of these cells differ. FIG. 3 is a view which explains UL-DL configurations of a scheduling cell and a scheduled cell. Reference notations 60 and 61 respectively indicate the UL-DL configurations of the scheduling cell and the scheduled cell. The methods of use of the reference notations, in FIG. 6, FIG. 10, FIG. 20, FIG. 24A, FIG. 24B, FIG. 25, FIG. 27A, FIG. 27B, FIG. 28A, FIG. 28B, FIG. 29A, FIG. 29B, FIG. 30A, FIG. 30B, and FIG. 31, are similar.

FIG. 3 illustrates the case where the UL-DL configurations of the scheduling cell and the scheduled cell are respectively “1” and “2” in FIG. 2. In this case, the subframes 3 and 8 are allocated to the downlink at the scheduled cell, while they are allocated to the uplink at the scheduling cell. Therefore, at the subframes 3 and 8, the PDCCH signal and PDSCH signal are not sent by the same frames.

For this reason, the base station 2 transmits a PDCCH signal, which indicates the radio resource allocation of the PDSCH signal to be transmitted by the subframe allocated for the uplink in the scheduling cell, by using the subframe which is allocated for the downlink of the scheduling cell. Note that, in the following explanation and attached drawings, transmission of radio resource allocation information will sometimes be expressed as “scheduling”.

In the example of FIG. 3, the base station 2 transmits the PDCCH signal for scheduling the PDSCH signal to be transmitted by the subframe 3, by using the subframe 1 which can transmit the PDCCH signal in the scheduling cell. Such a transmission of the PDSCH signal, in this way, by using a subframe which is different from the subframe for transmitting the PDCCH signal, will be referred to as “cross subframe scheduling”.

Further, the base station 2 may combine the PDSCH signal, which is transmitted by the subframe allocated to the uplink in the scheduling cell, with the PDSCH signal of another subframe, so as to realize scheduling by a single PDCCH signal. In the example of FIG. 3, the base station 2 may combine the PDSCH signal, which is transmitted by the subframe 3, with the PDSCH signal of the subframe 1 for scheduling by the PDCCH signal to be transmitted by the subframe 1. Such use of a single PDCCH signal, in this way, to indicate a plurality of subframes by which the PDSCH signal is transmitted, will be referred to as “multiple subframe scheduling”. Note that in the following explanation, cross subframe scheduling and multiple subframe scheduling will sometimes be referred to, all together, as “cross subframe scheduling etc.”

When performing cross subframe scheduling etc., the base station 2 jointly codes information, which indicates the subframe for transmission of a PDSCH signal, with other downlink control information (DCI) which is transmitted by the PDCCH or allocates, to a bit string, combinations of information indicating the subframe which transmits the PDSCH signal and other downlink control information which is transmitted by the PDCCH. Note that, in the following explanation and attached drawings, the information which indicates a subframe which transmits the PDSCH signal will sometimes be indicated as “subframe information”.

### 1.2. Functional Configuration

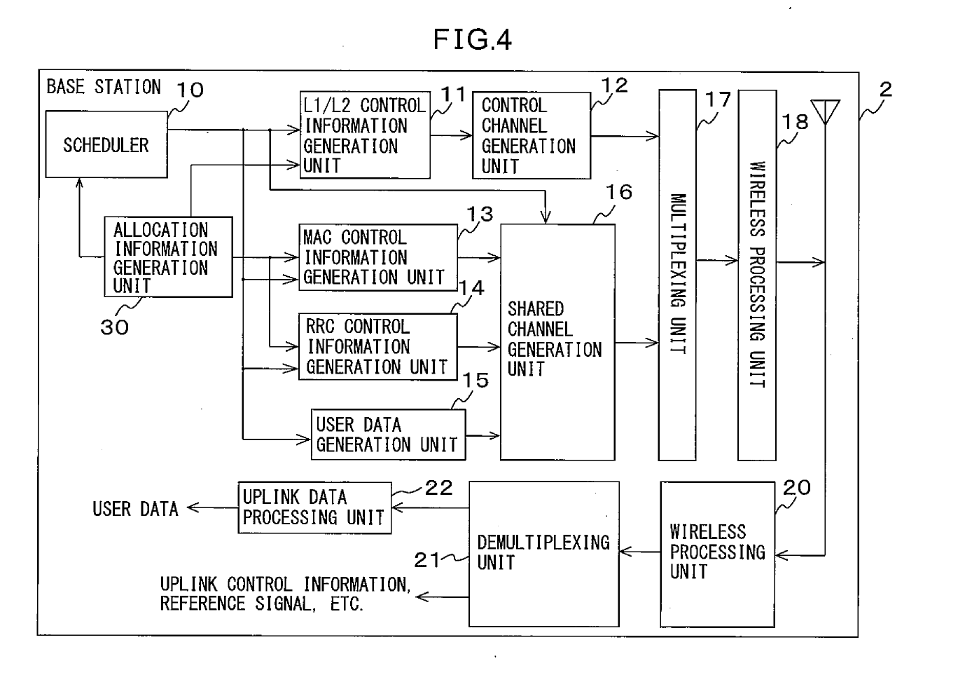

FIG. 4 is a view of the functional configuration of one example of a base station 2. The base station 2 is provided with a scheduler 10, L1 (Layer 1)/L2 (Layer 2) control information generation unit 11, control channel generation unit 12, and MAC (Media Access Control) control information generation unit 13. The base station 2 is provided with an RRC (Radio Resource Control) control information generation unit 14, user data generation unit 15, shared channel generation unit 16, multiplexing unit 17, and wireless processing unit 18. The base station 2 is provided with a wireless processing unit 20, demultiplexing unit 21, uplink data processing unit 22, and allocation information generation unit 30.

The scheduler 10 allocates radio resources for downlink communication or uplink communication of the mobile station 3 in accordance with the UL-DL configuration of the frequency band of the cell or the CC, which the mobile station 3 uses. The radio resources are, for example, the frequency or time slot which is used for communication.

The L1/L2 control information generation unit 11 generates L1/L2 control information for a control between the physical layers and MAC layers. One example of L1/L2 control information is downlink control information. A plurality of formats are used for downlink control information. The format of downlink control information is called the “DCI format”.

For example, for transmitting the carrier indicator field (CIF) which indicates the CC to be used by the mobile station 3, the DCI formats 0, 1, 1A, 1B, 1D, 2, 2A, 2B, 2C, and 4 are used. Further, for transmission of the HARQ process number which indicates the process in the HARQ, the DCI formats 1, 1A, 1B, 1D, 2, 2A, 2B, and 2C are used. The control channel generation unit 12 codes and modulates the L1/L2 control information, which is generated by the L1/L2 control information generation unit 11, to thereby generate a PDCCH signal and then output it to the multiplexing unit 17.

The MAC control information generation unit 13 generates MAC-CE (Medium Access Control-Control Element) control information and outputs it to the shared channel generation unit 16. The RRC control information generation unit 14 generates RRC control information and outputs it to the shared channel generation unit 16. The user data generation unit 15 generates user data and output it to the shared channel generation unit 16. The shared channel generation unit 16 codes and modulates a data block, which includes at least one of the MAC-CE control information, RRC control information, and user data as a “transport block”, to generate a PDSCH signal and outputs it to the multiplexing unit 17.

The multiplexing unit 17 multiplexes the outputs of the control channel generation unit 12 and the shared channel generation unit 16, processes the multiplex information by an inverse fast Fourier transform to convert it to a multiplex signal of the time domain, and outputs the multiplex signal of the time domain to the wireless processing unit 18. The wireless processing unit 18 converts the multiplex signal of a base band to a wireless signal of the wireless band and transmits it to the mobile station 3.

The wireless processing unit 20 receives the wireless signal transmitted from the mobile station 3. The wireless processing unit 20 converts the received wireless signal of the wireless band to a received signal of a base band. The demultiplexing unit 21 demultiplexes the data signal, uplink control information, reference signal, etc. from the received signal. The demultiplexing unit 21 outputs the data signal, which is demultiplexed from the received signal, to the uplink data processing unit 22. The uplink data processing unit 22 demodulates and decodes the data signal to extract the user data. The user data is transmitted to a higher control apparatus or otherwise output to another processing unit.

The allocation information generation unit 30 generates allocation information which is used for joint coding the subframe information and downlink control information. The allocation information indicates allocation of a subframe number, at which the PDSCH signal is transmitted, for each value of the downlink control information.

Here, the 3-bit CIF, which is part of the downlink control information, is used for indicating the CC by which the PDSCH is transmitted, but not all of the 3-bit bit pattern is completely used. For this reason, the base station 2 of the present embodiment jointly codes information of the component carrier indicated by the CIF and the subframe information. In the following explanation, information of the component carrier indicated by the CIF is referred to as “CI”.

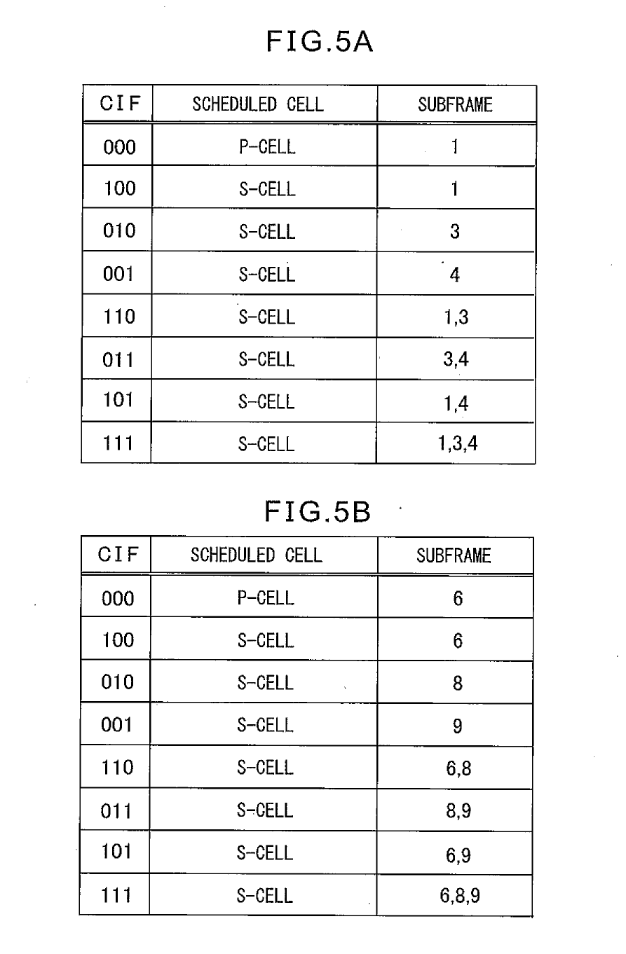

FIG. 5A and FIG. 5B are explanatory views of examples of allocation information. This allocation information is used when the UL-DL configuration of the scheduling cell is “0” and when the UL-DL configuration of the scheduled cell is “2”. FIG. 6 is a view which explains the UL-DL configurations of the scheduling cell and the scheduled cell. Below, unless explained otherwise, the scheduling cell is a primary cell, while the scheduled cell is a secondary cell. Note that, in another embodiment, the scheduling cell may be the secondary cell while the scheduled cell may be the primary cell. Further, in the present embodiment and subsequent embodiments, the scheduling cell can simultaneously be a scheduled cell. In the following explanation and attached drawings, the primary cell and the secondary cell will respectively be referred to as “P-cell” and “S-cell”.

At the subframes 0 and 5, both of the P-cell and S-cell are allocated for downlink, so cross subframe scheduling or multiple subframe scheduling is not required for the PDSCH signal to be transmitted by the subframes 0 and 5. In the P-cell, the subframes 3, 4, 8, and 9 are allocated for the uplink, while in the S-cell, the subframes 3, 4, 8, and 9 are allocated for the downlink. The PDCCH signal, which schedules the PDSCH signal to be transmitted by the subframe 3 and/or 4 of the S-cell, is transmitted by the special subframe 1. Further, the PDCCH signal, which schedules the PDSCH signal to be transmitted by the subframe 8 and/or 9 of the S-cell, is transmitted by the special subframe 6.

In this way, among the subframes which enable downlink transmission in the P-cell, the subframe 1, which is before the subframe 3 or 4 and is closer to the subframe 3 or 4, may be given priority to the use for transmission of the PDCCH signal which schedules the PDSCH signal of the subframe 3 or 4. Similarly, among the subframes which are allocated for the downlink in the P-cell, the subframe 6, which is before the subframe 8 or 9 and closer to the subframe 8 or 9, may be given priority to the use for transmission of the PDCCH signal which schedules the PDSCH signal of the subframe 8 or 9. In this way, by giving priority to a subframe, which is closer to the subframe transmitting the PDSCH signal, for use of transmission of the PDCCH signal which schedules the PDSCH signal, it is possible to advance the timing of transmission of the PDSCH signal and reduce the time delay of the signal. Further, by using a subframe which is closer to the subframe transmitting the PDSCH signal to transmit the PDCCH signal, a newer scheduling becomes possible, which can reflect a condition of transmission path and other circumstances.

FIG. 5A illustrates allocation information for indicating the transmitting subframe of a PDSCH signal by a CIF which is transmitted by the subframe 1 of the P-cell. The 3-bit CIF “000” indicates that a PDSCH signal is transmitted by the subframe 1 of the P-cell, while the CIF “100” indicates that a PDSCH signal is transmitted by the subframe 1 of the S-cell. The CIFs “010” and “001” indicate that PDSCH signals are transmitted by the subframes 3 and 4 of the S-cell respectively. When the values of CIFs are “010” and “001”, cross subframe scheduling is performed.

Further, when the CIF is “110”, PDSCH signals are transmitted, in multiple subframe scheduling, by both of the subframes 1 and 3 of the S-cell. Similarly, the CIFs “011”, “101”, and “111” indicate that PDSCH signals are transmitted by both the subframes 3 and 4, both 1 and 4, and all of 1, 3, and 4 of the S-cell, respectively.

FIG. 5B illustrates the allocation information for indicating the transmitting subframe of a PDSCH signal by a CIF which is transmitted by the subframe 6 of the P-cell. The CIF “000” indicates that a PDSCH signal is transmitted by the subframe 6 of the P-cell, while the CIF “100” indicates that a PDSCH signal is transmitted by the subframe 6 of the S-cell. The CIFs “010” and “001” indicate that PDSCH signals are transmitted by the subframes 8 and 9 of the S-cell respectively. Further, the CIFs “110”, “011”, “101”, and “111” indicate that PDSCH signals are respectively transmitted by both of the subframes 6 and 8, both of 8 and 9, both of 6 and 9, and all of 6, 8, and 9 of the S-cell.

In the above example, the transmission of the PDCCH signal, which schedules the PDSCH signals of the subframes 3 and 4, and the transmission of the PDCCH signal, which schedules the PDSCH signals of the subframes 8 and 9, are carried out by the subframes 1 and 6, respectively. In this case, the subframes 1, 3, and 4 are indicated, as the transmitting subframe of the PDSCH signal, by the PDCCH signal of the subframe 1. The combinations, selecting either subframe of these subframes 1, 3, and 4, are 1, 3, 4, both 1 and 3, both 3 and 4, both 1 and 4, and all of 1, 3, and 4. These combinations can all be identified by the CIFs shown in FIG. 5A. With respect to the CIFs transmitted by the subframe 6, it is possible to identify all combinations for selecting any subframe from the subframes 6, 8, and 9, as well, in the same way as mentioned above.

Refer to FIG. 4. When the allocation information generation unit 30 generates allocation information in accordance with the UL-DL configuration of the cell allocated to the mobile station 3, the unit 30 outputs the allocation information to the scheduler 10, L1/L2 control information generation unit 11, and MAC control information generation unit 13. In another embodiment, the allocation information generation unit 30 may output the allocation information to the RRC control information generation unit 14, instead of to the MAC control information generation unit 13 or in addition to the MAC control information generation unit 13.

When the MAC control information generation unit 13 receives the allocation information, the MAC control information generation unit 13 outputs the allocation information, as MAC-CE control information, to the shared channel generation unit 16. In this case, the allocation information is transmitted as MAC-CE control information to the mobile station 3. When the RRC control information generation unit 14 receives the allocation information, the RRC control information generation unit 14 outputs the allocation information, as the RRC control information, to the shared channel generation unit 16. In this case, the allocation information is transmitted, as RRC control information, to the mobile station 3.

The scheduler 10 selects the subframe allocated to the PDSCH signal and cell from the subframes allocated by the allocation information to any values of the CIFs or their combinations, when allocating radio resources to the PDSCH signal. The L1/L2 control information generation unit 11 generates a CIF in accordance with the subframe and cell which the scheduler 10 selected and transmits the CIF as downlink control information to the mobile station 3.

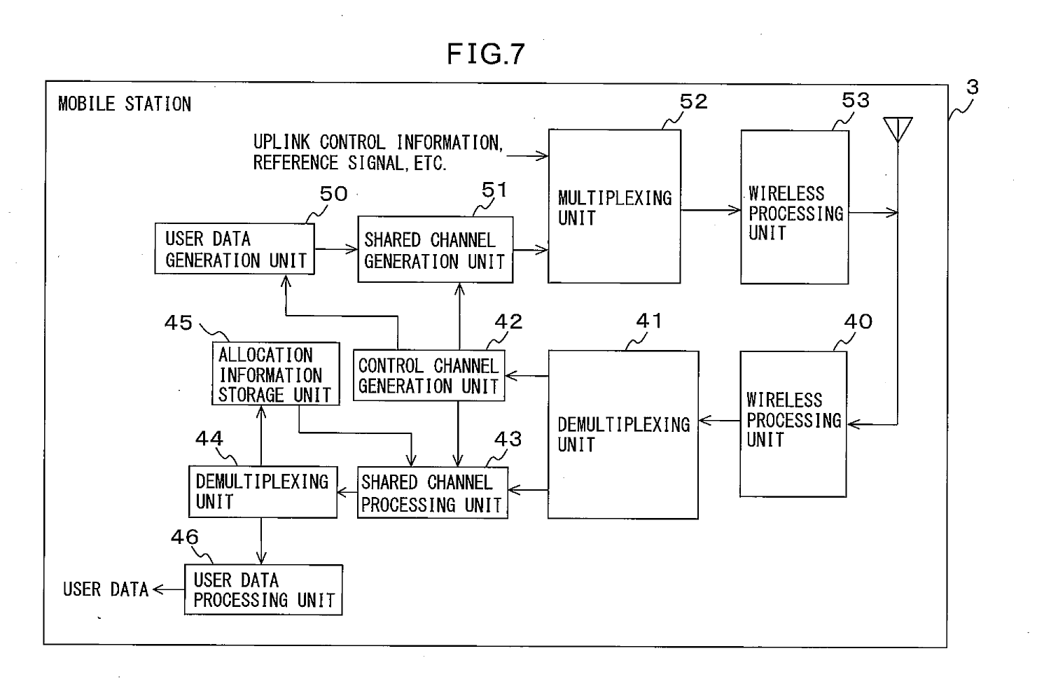

Referring to FIG. 7, one example of the functional configuration of the mobile station 3 will be explained. The mobile station 3 is provided with a wireless processing unit 40, demultiplexing unit 41, control channel processing unit 42, shared channel processing unit 43, demultiplexing unit 44, allocation information storage unit 45, and user data processing unit 46. The mobile station 3 is provided with a user data generation unit 50, shared channel generation unit 51, multiplexing unit 52, and wireless processing unit 53.

The wireless processing unit 40 receives the wireless signal which is transmitted from the base station 2. The wireless processing unit 40 converts the received wireless signal of the wireless band to a signal of the base band as a received signal. The demultiplexing unit 41 demultiplexes from the received signal to the control channel and shared channel. The control channel includes the L1/L2 control information which was transmitted on the PDCCH. The shared channel includes the MAC-CE control information, RRC control information, or user data, transmitted on the PDSCH.

The demultiplexing unit 41 outputs the downlink signal to the control channel processing unit 42 and the shared channel processing unit 43. The control channel processing unit 42 detects the PDCCH signal from the downlink signal and extracts various control information from the detected PDCCH signal. For example, the control channel processing unit 42 extracts the radio resource allocation information of the PDSCH and the radio resource allocation information of the uplink shared channel PUSCH (physical uplink shared channel). Further, the control channel processing unit 42 extracts the CIF transmitted as the L1/L2 control information or HARQ process number. Furthermore, the control channel processing unit 42 extracts size information which indicates the length of the uplink data transmitted from the mobile station 3. The control channel processing unit 42 outputs the radio resource allocation information of the downlink shared channel PDSCH and the CIF to the shared channel processing unit 43. The control channel processing unit 42 outputs the radio resource allocation information of the PUSCH to the shared channel generation unit 51. The control channel processing unit 42 outputs the size information to the user data generation unit 50.

The shared channel processing unit 43 uses the radio resource allocation information of the PDSCH and the CIF as the basis to detect the PDSCH from the downlink link signal. The shared channel processing unit 43 extracts the data signal, MAC-CE control information, and RRC control information from the PDSCH signal. The shared channel processing unit 43 outputs the data signal, MAC-CE control information, and RRC control information to the demultiplexing unit 44.

The demultiplexing unit 44 outputs the data signal to the user data processing unit 46. When the allocation information is given as MAC-CE control information from the base station 2, the demultiplexing unit 44 stores the allocation information, which is obtained from the MAC-CE control information, in the allocation information storage unit 45. When the allocation information is given as RRC control information from the base station 2, the demultiplexing unit 44 stores the allocation information, which is obtained from the RRC control information, in the allocation information storage unit 45. The shared channel processing unit 43, when detecting the PDSCH signal, uses the allocation information stored in the allocation information storage unit 45 and the CIF received from the control channel processing unit 42 as the basis and specifies the subframe by which the PDSCH signal is transmitted. The shared channel processing unit 43 detects the PDSCH signal from the specified subframe.

The user data processing unit 46 processes, at an application layer or other higher layer, the user data received from the demultiplexing unit 44. The shared channel generation unit 51 codes and modulates the user data, which the user data generation unit 50 generated in accordance with the size information, to generate a PDSCH signal and then outputs the generated PDSCH signal to the multiplexing unit 52.

The multiplexing unit 52 multiplexes the output of the shared channel generation unit 51 with the uplink control information, reference signal, etc. The multiplexing unit 52 processes the thus multiplexed multiplex information by a fast Fourier transform and maps the transformed frequency signal at a predetermined frequency. The multiplexing unit 52 processes the multiplex signal mapped at the predetermined frequency by an inverse fast Fourier transform to generate a time domain multiplex signal. The multiplexing unit 52 outputs the time domain multiplex signal to the wireless processing unit 53. The wireless processing unit 53 converts the multiplex signal of the base band to a wireless signal of the wireless band and transmits it to the base station 2.

### 1.3. Explanation of Operation

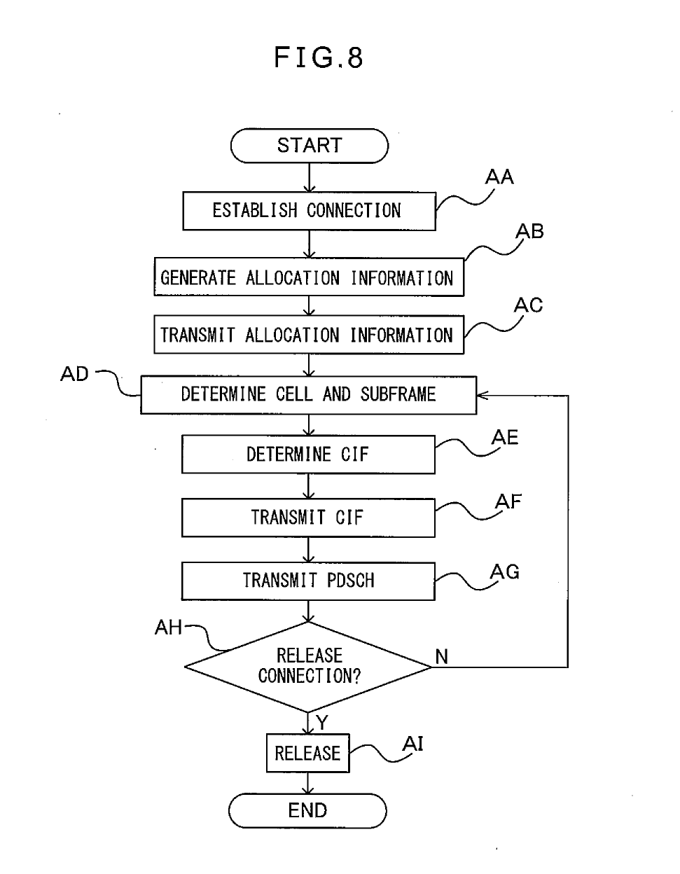

Next, the operations of the base station 2 and the mobile station 3 will be explained. FIG. 8 is a view which explains one example of the operation of the base station 2. At the operation AA, the base station and the mobile station establish a connection therebetween. At the operation AB, the allocation information generation unit 30 uses the UL-DL configuration of the frequency band of the cell which is used by the mobile station 3, as the basis, to generate allocation information. At the operation AC, the MAC control information generation unit 13 generates MAC-CE control information including allocation information and transmits the MAC-CE control information to the mobile station 3 through the shared channel generation unit 16, multiplexing unit 17, and wireless processing unit 18.

At the operation AD, the scheduler 10 determines the radio resources for transmitting the PDSCH signal. At this time, the scheduler 10 uses the UL-DL configuration of the frequency band of the cell used by the mobile station 3 and the allocation information, as the basis, to determine the subframe and cell for transmitting the PDSCH signal. At the operation AE, the L1/L2 control information generation unit 11 generates a CIF in accordance with the subframe and cell which the scheduler 10 determined. At the operation AF, the L1/L2 control information generation unit 11 transmits the CIF to the mobile station 3 through the control channel generation unit 12, multiplexing unit 17, and wireless processing unit 18. At the operation AG, the shared channel generation unit 16 generates a PDSCH signal to be transmitted by radio resources allocated by the scheduler 10 and transmits the PDSCH signal through the multiplexing unit 17 and wireless processing unit 18 to the mobile station 3. At the operation AH, it is judged whether to release the connection. When not releasing it, the routine returns to the operation AD where scheduling is performed. When releasing it, the routine proceeds to the operation AI where the connection is released.

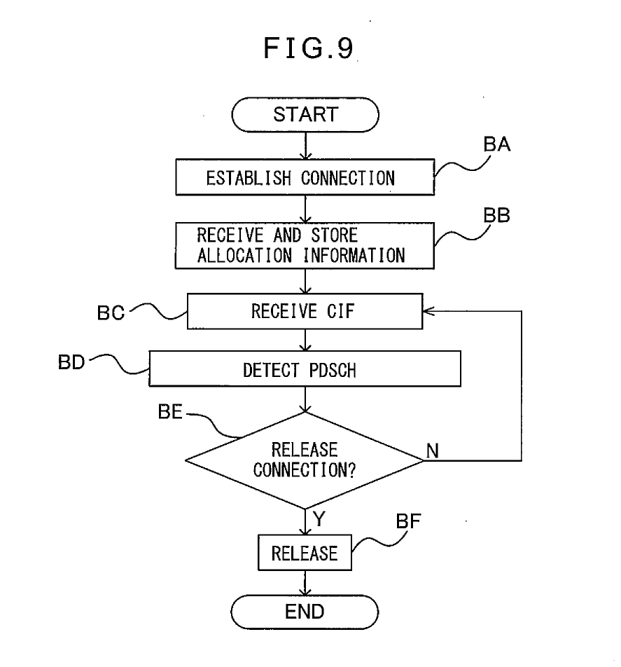

FIG. 9 is a view which explains an example of the operation of the mobile station 3. At an operation BA, the base station and the mobile station establish a connection therebetween. At the operation BB, the shared channel processing unit 43 acquires the MAC-CE control information from the PDSCH signal, and the demultiplexing unit 44 stores the allocation information, obtained from the MAC-CE control information, in the allocation information storage unit 45. At the operation BC, the control channel processing unit 42 extracts the radio resource allocation information of the PDSCH and the CIF from the PDCCH signal and outputs them to the shared channel processing unit 43. At the operation BD, the shared channel processing unit 43 uses the radio resource allocation information of the PDSCH and CIF and the allocation information stored in the allocation information storage unit 45, as the basis, to detect the PDSCH from the downlink signal. At the operation BE, it is judged whether to release the connection. When not releasing it, the routine returns to the operation BC where the control channel is detected. When releasing it, the routine proceeds to the operation BF where the connection is released. Note that, in the above operation which is explained with reference to FIG. 8 and FIG. 9, instead of the MAC-CE control information or in addition to the MAC-CE control information, the allocation information may be included in the RRC control information which is to be transmitted.

1.4. Examples of Setting of Allocation Information

Below, several examples of setting allocation information will be explained. FIG. 10 is a view which explains the UL-DL configurations of a scheduling cell and a scheduled cell. The example of FIG. 10 assumes the UL-DL configuration of the P-cell to be “0” and the UL-DL configuration of the S-cell to be “5”. In the P-cell, the subframes 3, 4, 7, 8, and 9 are allocated to the uplink, while in the S-cell, the subframes 3, 4, 7, 8, and 9 are allocated to the downlink. The PDCCH signal, which schedules the PDSCH signal to be transmitted by the subframe 3 and/or 4, is transmitted by the special subframe 1. Further, the PDCCH signal, which schedules the PDSCH signal to be transmitted by any of the subframes 7, 8, and 9, is transmitted by the special subframe 6.

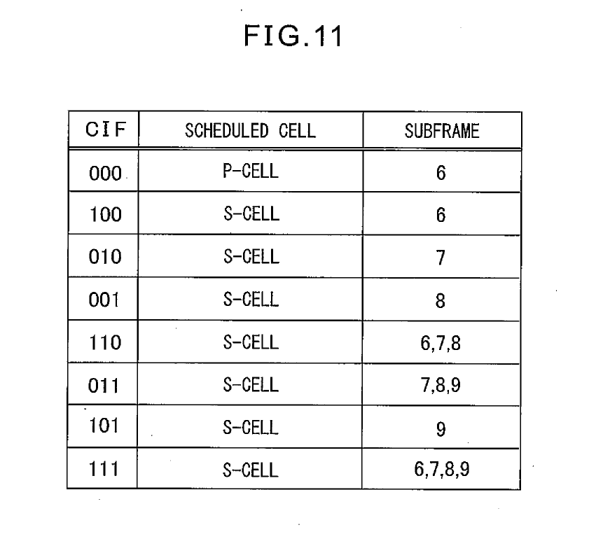

FIG. 11 is a view which explains examples of setting of allocation information which is used in the UL-DL configurations of FIG. 10. FIG. 11 illustrates allocation information for indicating the transmitting subframe of a PDSCH signal transmitted by the subframe 6 of the P-cell. The examples of transmitting the transmitting subframe of the PDSCH signal by the subframe 1 of the P-cell may, for example, be similar to the examples of setting of FIG. 5A.

The CIF “000” indicates that a PDSCH signal is transmitted by the subframe 6 of the P-cell, while the CIFs “100”, “010”, and “001” respectively indicate that PDSCH signals are transmitted by the subframes 6, 7, and 8 of the S-cell. Further, the CIFs “110”, “011”, “101”, and “111” respectively indicate that PDSCH signals are transmitted by all of the subframes 6, 7, and 8, all of 7, 8, and 9, 9, and all of 6, 7, 8, and 9 of the S-cell.

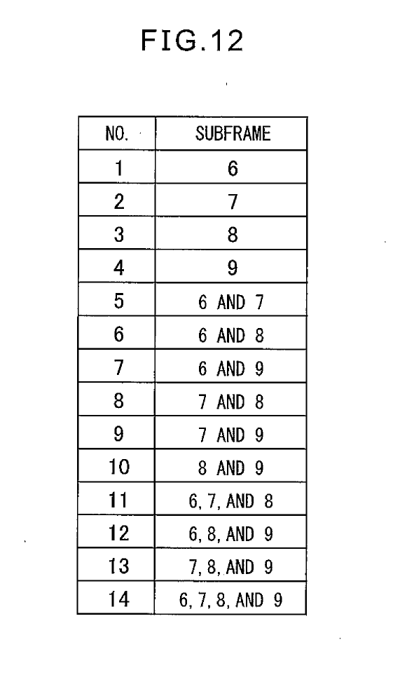

There are 14 combinations for selecting any subframes from among the subframes 6, 7, 8, and 9, as illustrated in FIG. 12. In the present embodiment, the 14 combinations are limited to combinations which use single subframes or three or four consecutive subframes to transmit the PDSCH. By limiting the patterns of combinations of the subframes for transmitting the PDSCH in this way, it is possible to limit the increase in the number of bits of a CIF which is generated by joint coding of subframe information with CI.

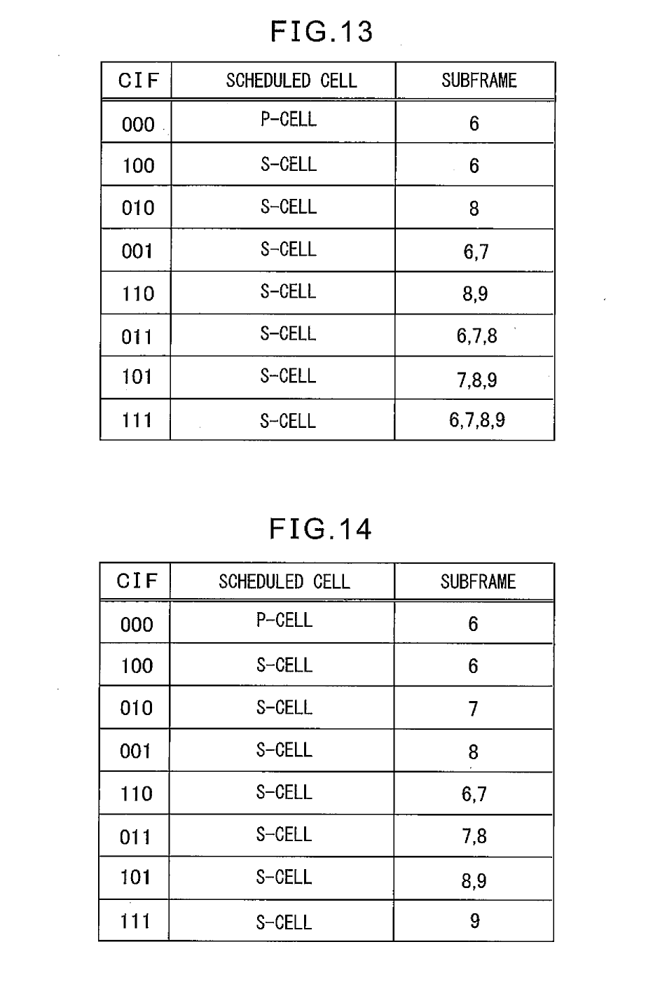

FIG. 13 is a view which explains other examples of setting allocation information used in the UL-DL configurations of FIG. 10. The CIF “000” indicates that a PDSCH signal is transmitted by the subframe 6 of the P-cell, while the CIFs “100”, “010”, and “001” respectively indicate that PDSCH signals are transmitted by the subframes 6, 8, and both 6 and 7 of the S-cell. Further, the CIFs “110”, “011”, “101”, and “111” respectively indicate that PDSCH signals are transmitted by both of the subframes 8 and 9, all of 6, 7, and 8, all of 7, 8, and 9, and all of 6, 7, 8, and 9 of the S-cell.

In the present examples of settings, the CIFs which indicate single subframes of the S-cells are respectively “100” and “010”, that is, two in number. Similarly, there are respectively two CIFs which indicate two or three subframes of the S-cells. There is one CIF which indicates four subframes of the S-cells. In the present embodiment, the difference in the number of bit patterns of the CIFs which indicate one, two, three, and four subframes from among the four subframes 6, 7, 8, and 9 of the S-cell becomes the minimum 2−1=1.

In this way, by evenly selecting various combinations of different numbers of subframes to allocate CIFs, it is possible to increase the variation in the number of subframes which are consecutively allocated to a user. As a result, it becomes possible to allocate a little of the radio resources at a time to as large a number of users as possible, while it becomes possible to allocate more radio resources at one time to a certain user so as to maximize the throughput. The two demands can therefore both be met.

FIG. 14 is a view which explains another example of setting allocation information which is used in the UL-DL configurations of FIG. 10. The CIF “000” indicates that a PDSCH signal is transmitted by the subframe 6 of the P-cell, while the CIFs “100”, “010”, and “001” respectively indicate that PDSCH signals are transmitted by the subframes 6, 7, and 8 of the S-cell. Further, the CIFs “110”, “011”, “101”, and “111” respectively indicate that PDSCH signals are transmitted by both of the subframes 6 and 7, both of 7 and 8, both of 8 and 9, and 9 of the S-cell.

In the present example of settings, the total number of subframes which are allocated for all of the bit patterns of the CIFs is 1+1+1+1+2+2+2+1=11. On the other hand, the total number of subframes which are allocated for the bit patterns, indicated by the example of settings of FIG. 13, is 1+1+1+2+2+3+3+4=17. In this way, in the present embodiment, the total number of subframes, which are allocated for all bit patterns, is smaller than the allocation information of FIG. 13 where the difference in the number of bit patterns of the CIFs which indicate different numbers of subframes from one to four of the S-cell, is the smallest.

By giving priority, in this way, to combinations of relatively small numbers of subframes in allocating the bit patterns of the CIFs, it becomes possible to allocate small amounts of radio resources to as large a number of users as possible.

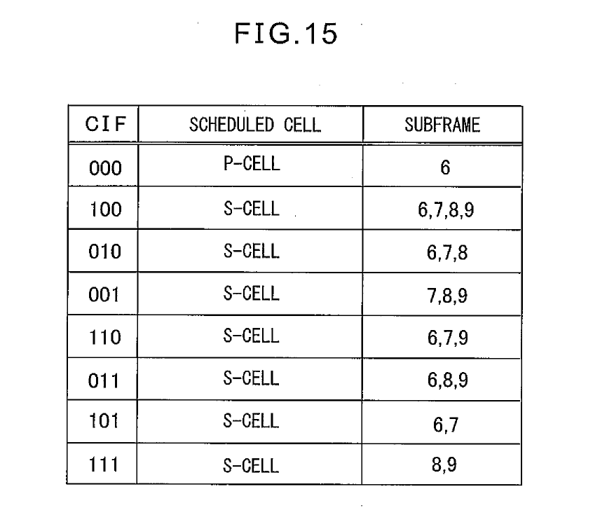

FIG. 15 is a view which explains another example of the settings of the allocation information used in the UL-DL configurations of FIG. 10. The CIF “000” indicates that a PDSCH signal is transmitted by the subframe 6 of the P-cell, while the CIFs “100” and “010” respectively indicate that PDSCH signals are transmitted by all of the subframes 6, 7, 8, and 9 and all of 6, 7, and 8 of the S-cell. The CIFs “001”, “110”, “011”, “101”, and “111” respectively indicate that PDSCH signals are transmitted by all of the subframes 7, 8, and 9, all of 6, 7, and 9, all of 6, 8, and 9, both of 6 and 7, and both of 8 and 9 of the S-cell.

In the present example of settings, the total number of subframes which are allocated for all of the bit patterns of the CIFs is 1+4+3+3+3+3+2+2=21. On the other hand, the total number of subframes which are allocated for the bit patterns, indicated by the example of settings of FIG. 13, is 17. In this way, in the present embodiment, the total number of subframes which are allocated for all bit patterns is larger than the allocation information of FIG. 13 where the difference in the number of bit patterns of the CIFs which indicate different numbers of subframes from one to four of the S-cell, is the smallest.

By giving priority, in this way, to combinations of relatively large numbers of subframes in allocating the bit patterns of the CIFs, it becomes possible to allocate a large amount of radio resources to a specific user at one time and maximize the throughput.

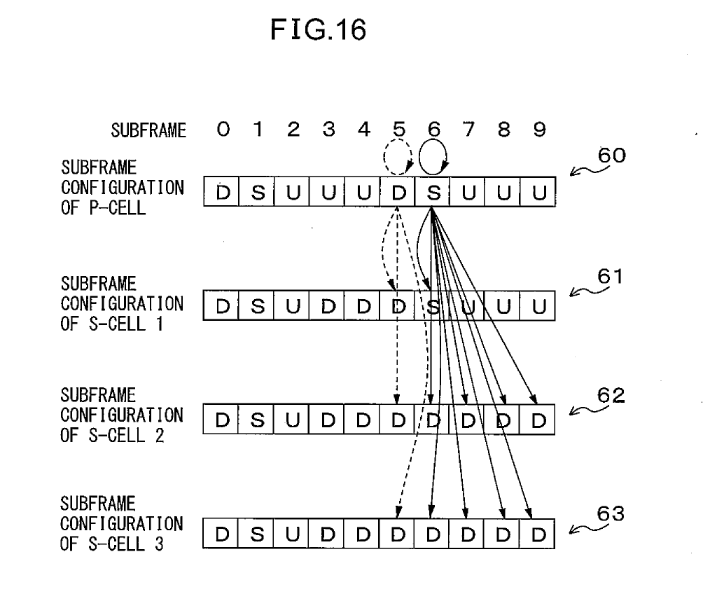

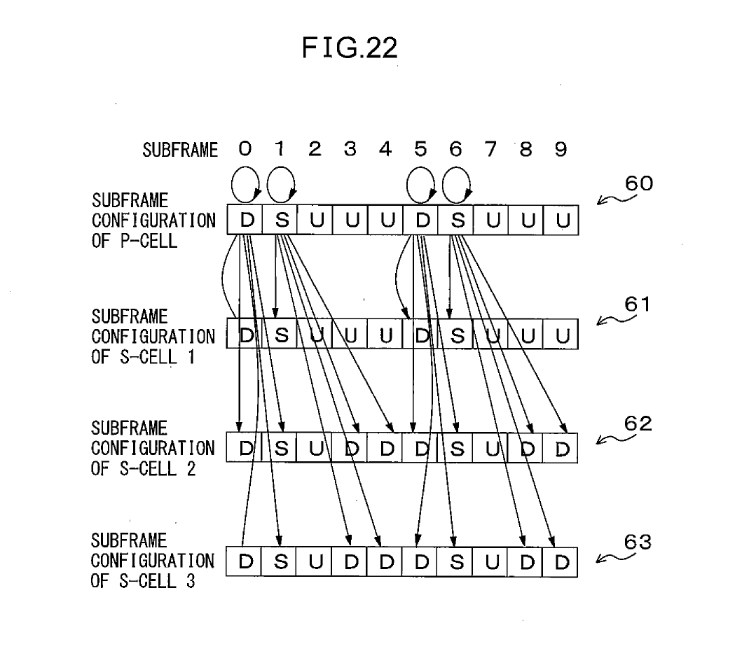

Next, another example of setting of the allocation information will be explained. Even in the case where the mobile station 3 sends and receives three or more CCs in parallel, the subframe information can be jointly coded with other downlink control information. FIG. 16 illustrates one example of the UL-DL configurations in the case where the mobile station 3 sends and receives CCs by four cells in parallel. In the example of FIG. 16, the scheduling cell is the P-cell, and the scheduled cells are the S-cell 1 to S-cell 3. Further, the P-cell and the S-cell 1 are CCs in the same frequency band and have UL-DL configurations of “0”. Further, the S-cell 2 and the S-cell 3 are CCs in the same frequency band and have UL-DL configurations of “5”. The frequency band of the P-cell and S-cell 1 and the frequency band of the S-cell 2 and S-cell 3 differ. Reference notations 60 to 63 respectively indicate the UL-DL configurations of the P-cell and S-cell 1 to S-cell 3. In FIG. 22 as well, the usage of the reference notations is the same.

Now, if focusing on the PDCCH which is transmitted by the special subframe 6 of the P-cell, the PDCCH signal, which schedules the PDSCH signal transmitted by the subframe 6 of the S-cell 1, is transmitted by the special subframe 6 of the P-cell. Further, the PDCCH signals, which schedule the PDSCH signals transmitted by the subframes 7 to 9 of the S-cells 2 and 3, are transmitted by the special subframe 6 of the P-cell.

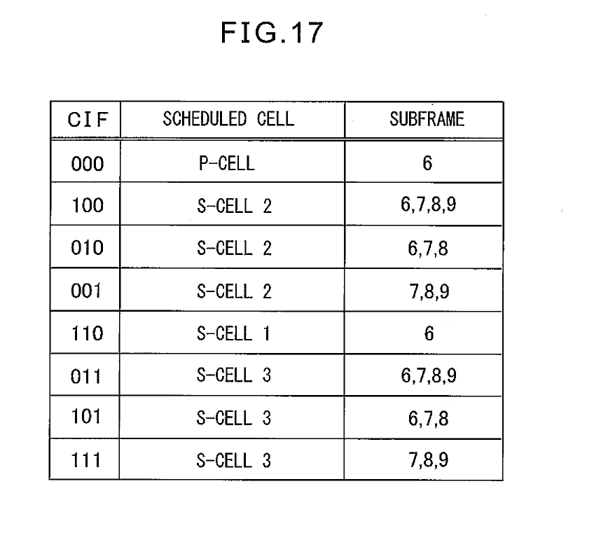

FIG. 17 is a view which explains an example of settings of allocation information which is used in the UL-DL configurations of FIG. 16. The CIF “000” indicates that a PDSCH signal is transmitted by the subframe 6 of the P-cell. The CIFs “100”, “010”, and “001” respectively indicate that PDSCH signals are transmitted by all of the subframes 6, 7, 8, and 9, all of 6, 7, and 8, and all of 7, 8, and 9 of the S-cell 2. Further, the CIF “110” indicates a PDSCH signal is transmitted by the subframe 6 of the S-cell 1. The CIFs “011”, “101”, and “111” respectively indicate that PDSCH signals are transmitted by all of the subframes 6, 7, 8, and 9, all of 6, 7, and 8, and all of 7, 8, and 9 of the S-cell 3. Note that, the allocation information for the CIFs which is transmitted by the special subframe 1 of the P-cell may be set separately from the example of settings of FIG. 17.

When transmitting the PDSCH signal by using the same frequency band as the P-cell, i.e., the scheduling cell, that is, the P-cell and S-cell 1, the UL-DL configurations are the same, so the same subframe can be used to transmit the PDCCH signal and the PDSCH signal, and thus cross subframe scheduling etc. need not be performed. For this reason, when transmitting the PDSCH signal by using the same frequency band as the P-cell, the CIFs need only be used for designation of the scheduled cell. Therefore, when, like in FIG. 17, the scheduling cell and the scheduled cell are cells in the same frequency band, a plurality of bit patterns of the CIFs need not be allocated. If jointly coding the subframe information with the CI in this way, it is possible to eliminate the indication of subframes in the case where the scheduling cell and the scheduled cell are cells in the same frequency band and possible to reduce the amount of consumption of the bit patterns of the CIFs.

In another embodiment, when the scheduling cell and the scheduled cell are cells in the same frequency band, it is also possible to indicate only the CC. In this case, the same subframe is used to transmit the PDCCH signal and PDSCH signal.

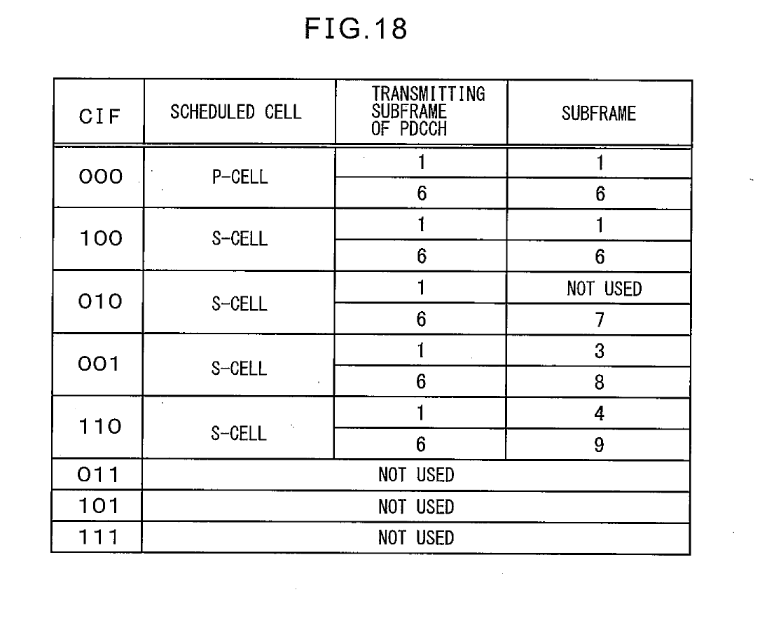

Next, another example of setting the allocation information will be explained. In the present embodiment, the number of consecutive subframes for transmitting the PDSCH is limited to one. That is, multiple subframe scheduling is not performed. FIG. 18 is a view which explains another example of setting allocation information which is used in the UL-DL configurations of FIG. 10.

When using a PDCCH signal which is transmitted by the subframe 1 of the P-cell to indicate the transmitting subframe of the PDSCH signal, the CIF “000” indicates that a PDSCH signal is transmitted by the subframe 1 of the P-cell. The CIFs “100”, “001”, and “010” respectively indicate that PDSCH signals are transmitted by the subframes 1, 3, and 4 of the S-cell. The CIFs “010”, “011”, “101”, and “111” are not used.

When using a PDCCH signal which is transmitted by the subframe 6 of the P-cell to indicate the transmitting subframe of the PDSCH signal, the CIF “000” indicates that a PDSCH signal is transmitted by the subframe 6 of the P-cell. The CIFs “100”, “010”, “001”, and “110” respectively indicate that PDSCH signals are transmitted by the subframes 6, 7, 8, and 9 of the S-cell. The CIFs “011”, “101”, and “111” are not used.

When not performing multiple subframe scheduling like in the present example of settings, the consumption of the bit patterns of the CIFs by using the joint coding of the subframe information, is reduced.

Note that, the above-mentioned illustrations of settings of allocation information are not meant to limit the allocation information, which is used in the communication apparatuses described in this specification, to only the illustrated settings. Various allocation information can be set in accordance with the UL-DL configurations. Different allocation information can also be set even for similar UL-DL configurations. The same is true in the following second embodiment and third embodiment as well.

1.5. Advantageous Effects

According to the present embodiment, the subframe information is jointly coded with the downlink control information for which not all of the bit patterns are used up. Due to this, the increase in downlink control information for cross subframe scheduling etc., when the scheduling cell and scheduled cell differ, is lessened.

Further, by jointly coding the subframe information and CI, it is possible to eliminate the indication of subframes when the scheduling cell and the scheduled cell are cells within the same frequency band and possible to reduce the amount of consumption of the bit patterns of the CIFs.

1.6. Modifications

The base station 2 may transmit one transport block as a whole by just one subframe. In this case, the L1/L2 control information generation unit 11 may allocate shared resource blocks and/or may apply the same modulation and coding scheme to the plurality of transport blocks which are included in the same subframe. On the other hand, the L1/L2 control information generation unit 11 may indicate at least one of the HARQ process number, new data indicator, and redundancy version for each transport block so that resend becomes possible for each transport block.

The base station 2 may also transmit one transport block over a plurality of subframes. In this case, the L1/L2 control information generation unit 11 may allocate shared resource blocks and/or apply a shared modulation coding scheme to the plurality of subframes by which one transport block is transmitted. Further, the L1/L2 control information generation unit 11 may indicate one HARQ process number, new data indicator, and redundancy version for one transport block.

Further, the communication apparatuses which are described in the present specification can be utilized not only for the case where the scheduling cell and the scheduled cell belong to different frequency bands, but also the case where different UL-DL configurations are used for a scheduling cell and scheduled cell of the same frequency band. Further, the communication apparatuses which are described in the present specification can operate even when the scheduling cell and the scheduled cell use the same UL-DL configuration. Further, when scheduling uplink data as well, in the same way as the example of scheduling the above downlink data, it is possible to jointly code the information for allocation of subframes to the PUSCH with the downlink control information.

### 2. Second Embodiment

Next, a second embodiment of joint coding of subframe information with downlink control information, will be explained. In the first embodiment, the PDCCH signal for scheduling the PDSCH signal can be transmitted by a downlink of the scheduling cell and is transmitted by only the closest subframe before the subframe by which the PDSCH signal is transmitted. In this case, the subframes, where cross subframe scheduling etc. are performed, concentrate at the special subframes. For this reason, if the number of the CCs, which are aggregated, or the number of the subframes, which are scheduled by cross subframe scheduling, increase, the limitation on combinations of CCs and subframes, which can be indicated by just the special subframes, becomes greater.

Therefore, in the present embodiment, the PDCCH signal which is used for cross subframe scheduling etc. is transmitted by both of the following two types of subframes:

(1) Closest subframe before the subframe by which the PDSCH signal is transmitted, which can be transmitted by a downlink in the scheduling cell.
(2) Closest subframe before the subframe of (1), which can be transmitted by a downlink in the scheduling cell.
For example, examples of the subframe of (1) are the special subframes 1 and 6. Examples of the subframe of (2) are the subframes 0 and 5 which are allocated to the downlink. These subframes are selected by the scheduler 10.

By increasing the subframes which are used for cross subframe scheduling etc. in this way, it is possible to lessen the concentrated use of a few subframes for cross subframe scheduling etc. As a result, even if the number of the CCs which are aggregated or the subframes which are scheduled by cross subframe scheduling increase, the limitation on combinations of CCs and subframes becomes smaller. Note that, in the following third embodiment as well, both the subframes of the above (1) and (2) may be used for cross subframe scheduling etc.

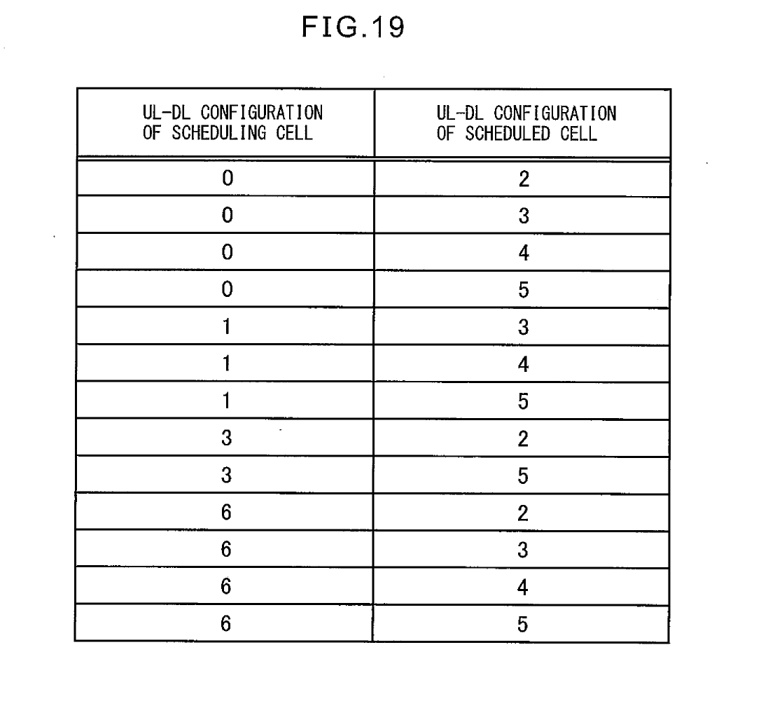

Below, examples of settings of allocation information will be studied for the case where three or more subframes of a scheduled cell, which differs in UL-DL configuration from a scheduling cell, are scheduled by a single subframe of the scheduling cell. This is because if the number of subframes scheduled by a single subframe schedules is two, even if dispersing this scheduling to another subframe, after this, the other subframe will schedule two subframes so the effect of dispersion will not be that great. The combinations of UL-DL configurations to be studied are illustrated in FIG. 19.

(1) Case when the UL-DL configuration of the scheduling cell is “0” and the UL-DL configuration of the scheduled cell is “2” to “5”.

(2) Case when the UL-DL configuration of the scheduling cell is “1” and the UL-DL configuration of the scheduled cell is “3” to “5”.

(3) Case when the UL-DL configuration of the scheduling cell is “3” and the UL-DL configuration of the scheduled cell is “2” or “5”.

(4) Case when, further, the UL-DL configuration of the scheduling cell is “6” and the UL-DL configuration of the scheduled cell is “2” to “5”.

First, assume the case where there are one each of a scheduling cell and scheduled cell, the UL-DL configuration of the P-cell as the scheduling cell is “0”, and the UL-DL configuration of the S-cell as the scheduled cell is “2”. FIG. 20 shows the UL-DL configurations.

When using just the special subframes 1 and 6 to perform cross subframe scheduling etc., the subframes 1 and 6 schedule the PDSCH signals formed by three subframes of the S-cell. For example, the subframe 1 schedules the PDSCH signals of the subframes 1, 3, and 4. Further, for example, the subframe 6 schedules the PDSCH signals of the subframes 6, 8, and 9.

Therefore, even for the closest downlink subframes 0 and 5 before the special subframes 1 and 6 of the P-cell, the cross subframe scheduling etc. of the PDSCH signals of the subframes 1 and 6 of the S-cell are performed. By using such subframes to perform cross subframe scheduling etc., the maximum number of subframes of the S-cell, which each subframe schedules, is reduced from three to two.

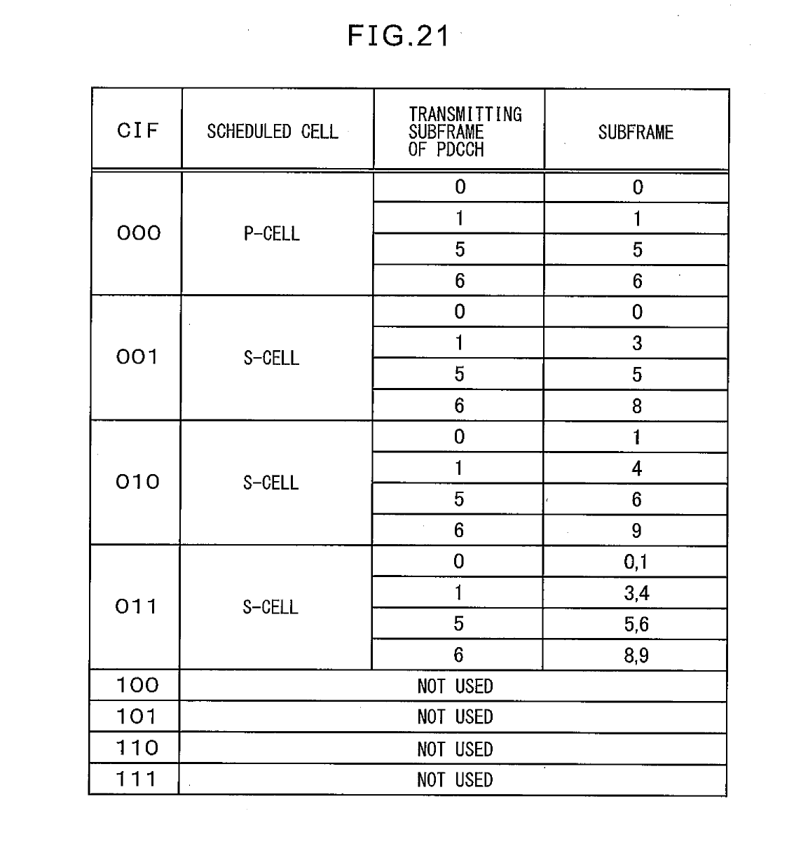

FIG. 21 is a view which explains another example of setting allocation information which is used in the UL-DL configurations of FIG. 20. When using a PDCCH signal, which is transmitted by the subframe 0 of the P-cell, to indicate the transmitting subframe of the PDSCH signal, the CIF “000” indicates that a PDSCH signal is transmitted by the subframe 0 of the P-cell. The CIFs “001”, “010”, and “011” respectively indicate that PDSCH signals are transmitted by the subframes 0, 1, and both 0 and 1 of the S-cell.

When using a PDCCH signal, which is transmitted by the subframe 1 of the P-cell, to indicate the transmitting subframe of the PDSCH signal, the CIF “000” indicates that a PDSCH signal is transmitted by the subframe 1 of the P-cell. The CIFs “001”, “010”, and “011” respectively indicate that PDSCH signals are transmitted by the subframes 3, 4, and both 3 and 4 of the S-cell.

When using a PDCCH signal, which is transmitted by the subframe 5 of the P-cell, to indicate the transmitting subframe of the PDSCH signal, the CIF “000” indicates that a PDSCH signal is transmitted by the subframe 5 of the P-cell. The CIFs “001”, “010”, and “011” respectively indicate that PDSCH signals are transmitted by the subframes 5, 6, and both 5 and 6 of the S-cell.

When using a PDCCH signal, which is transmitted by the subframe 6 of the P-cell, to indicate the transmitting subframe of the PDSCH signal, the CIF “000” indicates that a PDSCH signal is transmitted by the subframe 6 of the P-cell. The CIFs “001”, “010”, and “011” respectively indicate that PDSCH signals are transmitted by the subframes 8, 9, and both 8 and 9 of the S-cell. Note that, the CIFs “100”, “101”, “110”, and “111” are not used.

For example, when using the subframe 0 of the P-cell to transmit a PDSCH signal, it is sufficient to indicate the value of the CIF, which is transmitted by the subframe 0, as “000”. When using the subframe 0 of the S-cell to transmit a PDSCH signal, it is sufficient to indicate the value of the CIF, which is transmitted by the subframe 0, as “001”. When using the subframe 1 of the S-cell to transmit a PDSCH signal, it is sufficient to indicate the value of the CIF, which is transmitted by the subframe 0, as “010”.

When using the subframe 1 of the P-cell to transmit a PDSCH signal, it is sufficient to indicate the value of the CIF, which is transmitted by the subframe 1, as “000”. When using the subframe 3 of the S-cell to transmit a PDSCH signal, it is sufficient to indicate the value of the CIF, which is transmitted by the subframe 1, as “001”. When using the subframe 4 of the S-cell to transmit a PDSCH signal, it is sufficient to indicate the value of the CIF, which is transmitted by the subframe 1, as “010”.

When using both of the subframes 0 and 1 of the S-cell to transmit PDSCH signals, it is sufficient to indicate the value of the CIF, which is transmitted by the subframe 0, as “011”. When using both of the subframes 8 and 9 of the S-cell to transmit a PDSCH signal, it is sufficient to indicate the value of the CIF, which is transmitted by the subframe 6, as “011”.

Even when using a combination of a CC and first half subframes 0 to 4, other than the above combinations, to transmit a PDSCH signal, by suitably combining the values of CIFs which are transmitted by the subframes 0 and 1, it is possible to indicate all of the candidates for combination of the CCs and subframes. For example, when using the subframes 0 and 3 and 4 of the S-cell to transmit PDSCH signals, it is sufficient to indicate the value of the CIF, which is transmitted by the subframe 0, as “000” and indicate the value of the CIF, which is transmitted by the subframe 1, as “011”.

In the same way for the second half subframes 5 to 9 as well, it is possible to combine the values of CIFs, which are transmitted by the subframes 5 and 6, to indicate all the candidates for combinations of the CCs and subframes.

From the above, it will be understood that, if configured such as in FIG. 20, four CIF bit patterns are sufficient for indicating all of the candidates for combinations of the CCs and the subframes for transmitting PDSCH signals.

The UL-DL configurations which will be studied next are illustrated in FIG. 22. The mobile station 3 sends and receives signals for four cells in parallel. In the example of FIG. 22, the scheduling cell is the P-cell, while the scheduled cells are the S-cell 1 to S-cell 3. Further, the P-cell and the S-cell 1 are CCs within the same frequency band. The UL-DL configuration is “0”. Further, the S-cell 2 and the S-cell 3 are CCs in the same frequency band. The UL-DL configuration is “2”. The frequency bands of the P-cell and S-cell 1 and the frequency bands of the S-cell 2 and S-cell 3 differ.

The downlink subframe 0 of the P-cell schedules the PDSCH signals of the subframes 0 and 1 of the S-cells 2 and 3. The special subframe 1 of the P-cell schedules the PDSCH signals of the subframes 3 and 4 of the S-cells 2 and 3. The downlink subframe 5 of the P-cell schedules the PDSCH signals of the subframes 5 and 6 of the S-cells 2 and 3. The special subframe 6 of the P-cell schedules the PDSCH signals of the subframes 8 and 9 of the S-cells 2 and 3.

Further, the subframes 0, 1, 5, and 6 of the P-cell schedule the PDSCH signals of the subframes 0, 1, 5, and 6 of the P-cell itself. Further, the subframes 0, 1, 5, and 6 of the P-cell schedule the PDSCH signals of the subframes 0, 1, 5, and 6 of the S-cell 1.

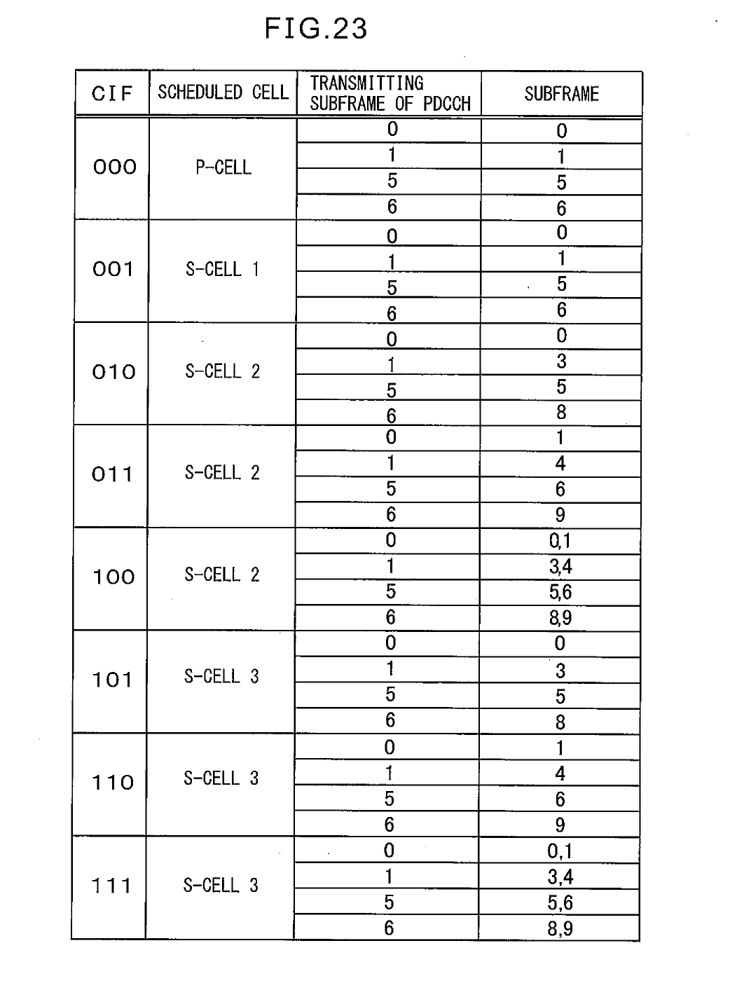

FIG. 23 is a view explaining an example of the settings of allocation information which is used in the UL-DL configurations of FIG. 22. When using a PDCCH signal, which is transmitted by the subframe 0 of the P-cell, to indicate the transmitting subframes of the PDSCH signal, the CIF “000” indicates that a PDSCH signal is transmitted by the subframe 0 of the P-cell. The CIF “001” indicates that a PDSCH signal is transmitted by the subframe 0 of the S-cell 1. The CIFs “010”, “011”, and “100” indicate that PDSCH signals are transmitted by the subframes 0, 1 and both 0 and 1 of the S-cell 2. The CIFs “101”, “110”, and “111” respectively illustrate that PDSCH signals are transmitted to the subframes 0, 1, and both 0 and 1 of the S-cell 3.

When using a PDCCH signal, which is transmitted by the subframe 1 of the P-cell, to indicate the transmitting subframe of the PDSCH signal, the CIF “000” indicates that a PDSCH signal is transmitted by the subframe 1 of the P-cell. The CIF “001” indicates that a PDSCH signal is transmitted by the subframe 1 of the S-cell 1. The CIFs “010”, “011”, and “100” respectively indicate that PDSCH signals are transmitted by the subframes 3, 4, and both 3 and 4 of the S-cell 2. The CIFs “101”, “110”, and “111” respectively indicate that PDSCH signals are transmitted by the subframes 3, 4, and both 3 and 4 of the S-cell 3.

When using a PDCCH signal, which is transmitted by the subframe 5 of the P-cell, to indicate the transmitting subframe of the PDSCH signal, the CIF “000” indicates that a PDSCH signal is transmitted by the subframe 5 of the P-cell. The CIF “001” indicates that a PDSCH signal is transmitted by the subframe 5 of the S-cell 1. The CIFs “010”, “011”, and “100” indicate that PDSCH signals are transmitted by the subframes 5, 6, and both 5 and 6 of the S-cell 2. The CIFs “101”, “110”, and “111” indicate that PDSCH signals are transmitted by subframes 5, 6, and both 5 and 6 of the S-cell 3.

When using a PDCCH signal, which is transmitted by the subframe 6 of the P-cell, to indicate the transmitting subframe of the PDSCH signal, the CIF “000” indicates a PDSCH signal is transmitted by the subframe 6 of the P-cell. The CIF “001” indicates a PDSCH signal is transmitted by the subframe 6 of the S-cell 1. The CIFs “010”, “011”, and “100” indicate that PDSCH signals are transmitted by the subframes 8, 9, and both 8 and 9 of the S-cell 2. The CIFs “101”, “110”, and “111” indicate that PDSCH signals are transmitted by subframes 8, 9, and both 8 and 9 of the S-cell 3.

For example, when using the subframe 0 of the P-cell to transmit a PDSCH signal, it is sufficient to indicate the value of the CIF, which is transmitted by the subframe 0 of the P-cell, as “000”. When using the subframe 0 of the S-cell 1 to transmit a PDSCH signal, it is sufficient to indicate the value of the CIF, which is transmitted by the subframe 0, as “001”. When using the subframe 0 of the S-cell 2 to transmit a PDSCH signal, it is sufficient to indicate the value of the CIF, which is transmitted by the subframe 0, as “010”. When using the subframe 1 of the S-cell 2 to transmit a PDSCH signal, it is sufficient to indicate the value of the CIF, which is transmitted by the subframe 0, as “011”. When using the subframe 0 of the S-cell 3 to transmit a PDSCH signal, it is sufficient to indicate the value of the CIF, which is transmitted by the subframe 0, as “101. When using the subframe 1 of the S-cell 3 to transmit a PDSCH signal, it is sufficient to indicate the value of the CIF, which is transmitted by the subframe 0, as “110”.

Further, when using the subframe 1 of the P-cell to transmit a PDSCH signal, it is sufficient to indicate the value of the CIF, which is transmitted by the subframe 1 of the P-cell, as “000”. When using the subframe 1 of the S-cell 1 to transmit a PDSCH signal, it is sufficient to indicate the value of the CIF, which is transmitted by the subframe 1, as “001”. When using the subframe 3 of the S-cell 2 to transmit a PDSCH signal, it is sufficient to indicate the value of the CIF, which is transmitted by the subframe 1, as “010”. When using the subframe 4 of the S-cell 2 to transmit a PDSCH signal, it is sufficient to indicate the value of the CIF, which is transmitted by the subframe 1, as “011”. When using the subframe 3 of the S-cell 3 to transmit a PDSCH signal, it is sufficient to indicate the value of the CIF, which is transmitted by the subframe 1, as “101”. When using the subframe 4 of the S-cell 3 to transmit a PDSCH signal, it is sufficient to indicate the value of the CIF, which is transmitted by the subframe 1, as “110”.

When using both of the subframes 0 and 1 of the S-cell 2 to transmit PDSCH signals, it is sufficient to indicate the value of the CIF, which is transmitted by the subframe 0, as “100”. When using both of the subframes 3 and 4 of the S-cell 2 to transmit PDSCH signals, it is sufficient to indicate the value of the CIF, which is transmitted by the subframe 1, as “100”. When using both of the subframes 0 and 1 of the S-cell 3 to transmit PDSCH signals, it is sufficient to indicate the value of the CIF, which is transmitted by the subframe 0, as “111”. When using both of the subframes 3 and 4 of the S-cell 3 to transmit PDSCH signals, it is sufficient to indicate the value of the CIF, which is transmitted by the subframe 1, as “111”.

Even when using combinations of CCs and the first half subframes 0 to 4, other than the above combinations, to transmit a PDSCH signal, by suitably combining the values of CIF which are transmitted by the subframes 0 and 1, it is possible to indicate all of the candidates of combinations of CCs and subframes. For example, when using the subframes 0, 3, and 4 of the S-cell 2 to transmit PDSCH signals, it is sufficient to indicate the value of the CIF, which is transmitted by the subframe 0, as “010” and sufficient to indicate the value of the CIF, which is transmitted by the subframe 1, as “100”.

In the same way for the latter half subframes 5 to 9 as well, it is possible to combine the values of CIFs, which are transmitted by the subframes 5 and 6 of the P-cell, to indicate all the candidates for combinations of the CCs and subframes.

FIG. 24A illustrates the case where there are one each of a scheduling cell and scheduled cell, the UL-DL configuration of the P-cell as the scheduling cell is “0”, and the UL-DL configuration of the S-cell as the scheduled cell is “3”.

The downlink subframe 0 of the P-cell schedules the PDSCH signal of the subframe 0 of the S-cell. The special subframe 1 of the P-cell schedules the PDSCH signals of the subframes 1 and 5 of the S-cell. The downlink subframe 5 of the P-cell schedules the PDSCH signals of the subframes 6 and 7 of the S-cell. The special subframe 6 of the P-cell schedules the PDSCH signals of the subframes 8 and 9 of the S-cell.

In the example of FIG. 24A, in the same way as the example of FIG. 20, there is only one S-cell of a UL-DL configuration different from the P-cell as the scheduled cell. The number of subframes of the S-cell where the subframes perform scheduling per each P-cell is a maximum 2. Therefore, in the same way as the UL-DL configurations of FIG. 20, four CIF bit patterns can indicate all of the candidates for combinations of the CCs and subframes which transmit PDSCH signals.

FIG. 24B illustrates the case where there are one each of a scheduling cell and scheduled cell, the UL-DL configuration of the P-cell as the scheduling cell is “0”, and the UL-DL configuration of the S-cell as the scheduled cell is “4”.

The downlink subframe 0 of the P-cell schedules the PDSCH signals of the subframes 0 and 1 of the S-cell. The special subframe 1 of the P-cell schedules the PDSCH signals of the subframes 4 and 5 of the S-cell. The downlink subframe 5 of the P-cell schedules the PDSCH signals of the subframes 6 and 7 of the S-cell. The special subframe 6 of the P-cell schedules the PDSCH signals of the subframes 8 and 9 of the S-cell.

In the example of FIG. 24B, in the same way as the example of FIG. 20, there is only one S-cell of a UL-DL configuration different from the P-cell as the scheduled cell. The number of subframes of the S-cell where the subframes perform scheduling per each P-cell is a maximum 2. Therefore, in the same way as the UL-DL configurations of FIG. 20, four CIF bit patterns can indicate all of the candidates for combinations of the CCs and subframes which transmit a PDSCH signal.

FIG. 25 illustrates the case where there are one each scheduling cell and scheduled cell, the UL-DL configuration of the P-cell as the scheduling cell is “0”, and the UL-DL configuration of the S-cell as the scheduled cell is “5”.

The downlink subframe 0 of the P-cell schedules the PDSCH signals of the subframes 0 and 1 of the S-cell. The special subframe 1 of the P-cell schedules the PDSCH signals of the subframes 3 and 4 of the S-cell. The downlink subframe 5 of the P-cell schedules the PDSCH signals of the subframes 5 and 6 of the S-cell. The special subframe 6 of the P-cell schedules the PDSCH signals of the subframes 7, 8, and 9 of the S-cell.

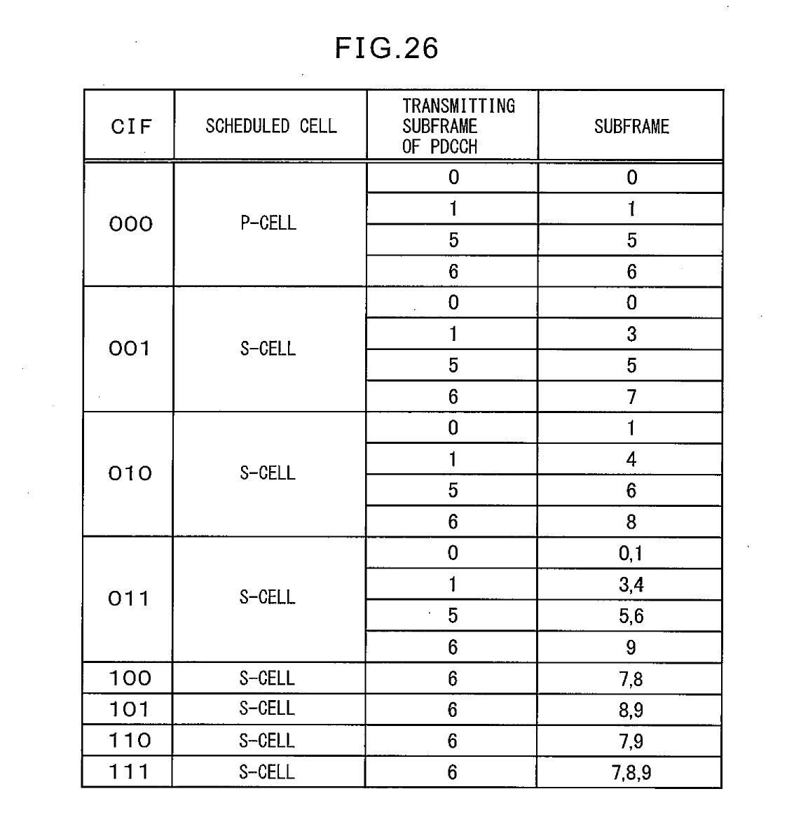

FIG. 26 is a view which explains another example of settings of the allocation information which is used in the UL-DL configurations of FIG. 25. When using a PDCCH signal, which is transmitted by the subframe 0 of the P-cell, to indicate the transmitting subframe of the PDSCH signal, the CIF “000” indicates that a PDSCH signal is transmitted by the subframe 0 of the P-cell. The CIFs “001” and “010” respectively indicate that the PDSCH signals are transmitted by the subframes 0 and 1 of the S-cell. The CIF “011” indicates that PDSCH signals are transmitted by both of the subframes 0 and 1 of the S-cell. The CIFs “100”, “101”, “110”, and “111” are unused.

When using a PDCCH signal, which is transmitted by the subframe 1 of the P-cell, to indicate the transmitting subframe of the PDSCH signal, the CIF “000” indicates that a PDSCH signal is transmitted by the subframe 1 of the P-cell. The CIFs “001” and “010” respectively indicate that PDSCH signals are transmitted by the subframes 3 and 4 of the S-cell. The CIF “011” indicates that PDSCH signals are transmitted by both of the subframes 3 and 4 of the S-cell. The CIFs “100”, “101”, “110”, and “111” are unused.

When using a PDCCH signal, which is transmitted by the subframe 5 of the P-cell, to indicate the transmitting subframe of the PDSCH signal, the CIF “000” indicates that a PDSCH signal is transmitted by the subframe 5 of the P-cell. The CIFs “001” and “010” respectively indicate that PDSCH signals are transmitted by the subframes 5 and 6 of the S-cell. The CIF “011” indicates that PDSCH signals are transmitted by both of the subframes 5 and 6 of the S-cell. The CIFs “100”, “101”, “110”, and “111” are unused.

When using a PDCCH signal, which is transmitted by the subframe 6 of the P-cell, to indicate the transmitting subframe of the PDSCH signal, the CIF “000” indicates that a PDSCH signal is transmitted by the subframe 6 of the P-cell. The CIFs “001”, “010”, and “0111” respectively indicate that PDSCH signals are transmitted by the subframes 7, 8, and 9 of the S-cell. The CIFs “100”, “101”, and “110” respectively indicate that PDSCH signals are transmitted by both of the subframes 7 and 8, both of 8 and 9, and both of 7 and 9 of the S-cell. The CIF “111” indicates that PDSCH signals are transmitted by all of the subframes 7, 8, and 9 of the S-cell.

The UL-DL configurations of the first half subframes 0 to 4 are similar to the UL-DL configurations of FIG. 20. Therefore, in the same way as the UL-DL configurations of FIG. 20, four CIF bit patterns can indicate all of the candidates for combinations of CCs and subframes which transmit PDSCH signals.

When using the subframe 5 of the P-cell to transmit a PDSCH signal, it is sufficient to indicate the value of the CIF, which is transmitted by the subframe 5 of the P-cell, as “000”. When using the subframe 6 of the P-cell to transmit a PDSCH signal, it is sufficient to indicate the value of the CIF, which is transmitted by the subframe 6 of the P-cell, as “000”. When using the subframes 5 and 6 of the S-cell to transmit PDSCH signals, it is sufficient to indicate the values of the CIFs, which are transmitted by the subframe 5, as “001” and “010”. When using the subframes 7, 8, and 9 of the S-cell to transmit PDSCH signals, it is sufficient to indicate the values of the CIFs, which are transmitted at the subframe 6, as “001”, “010”, and “011”.

When using both of the subframes 5 and 6 of the S-cell to transmit PDSCH signals, it is sufficient to indicate the value of the CIF, which is transmitted by the subframe 5, as “011”. When using both of the subframes 7 and 8, both of 8 and 9, and both of 7 and 9 of the S-cell to transmit PDSCH signals, it is sufficient to indicate the values of the CIFs, which are transmitted by the subframe 6, as “100”, “101”, and “110” respectively. When using all of the subframes 7, 8, and 9 of the S-cell to transmit the PDSCH signal, it is sufficient to indicate the value of the CIF, which is transmitted at the subframe 6, as “111”.

Even when using combinations of CCs and the latter half subframes 5 to 9, other than the above combinations, to transmit a PDSCH signal, by suitably combining the values of the CIF which are transmitted by the subframes 5 and 6, it is possible to indicate all of the candidates for combinations of CCs and subframes. For example, when using all of the subframes 5, and 6 and 7 and 9 to transmit PDSCH signals, it is sufficient to indicate the value of the CIF, which is transmitted by subframe 5, as “011” and indicate the value of the CIF, which is transmitted by the subframe 6, as “110”.

In this way, in the UL-DL configurations of FIG. 25 as well, by performing scheduling with the downlink subframes 0 and 5 and the special subframes 1 and 6, 3-bit CIFs can indicate all of the candidates for combinations of CCs and subframes which transmit PDSCH signals.

FIG. 27A illustrates the case where there are one each scheduling cell and scheduled cell, the UL-DL configuration of the P-cell as scheduling cell is “1”, and the UL-DL configuration of the S-cell as the scheduled cell is “3”.

The downlink subframe 0 of the P-cell schedules the PDSCH signal of the subframe 0 of the S-cell. The special subframe 1 of the P-cell schedules the PDSCH signal of the subframe 1 of the S-cell. The downlink subframe 5 of the P-cell schedules the PDSCH signals of both of the subframes 5 and 6 of the S-cell. The special subframe 6 of the P-cell schedules the PDSCH signals of both of the subframes 7 and 8 of the S-cell. Further, the downlink subframe 9 of the P-cell schedules the PDSCH signal of the subframe 9 of the S-cell.

In the example of FIG. 27A, in the same way as the example of FIG. 20, there is only one S-cell of a UL-DL configuration different from the P-cell as the scheduled cell. The number of subframes of the S-cell, where the subframes perform scheduling per each P-cell, is a maximum 2. Therefore, in the same way as the UL-DL configuration of FIG. 20, four CIF bit patterns can indicate all of the candidates of combinations of the CCs and subframes which transmit a PDSCH signal.

FIG. 27B illustrates the case where there are one each scheduling cell and scheduled cell, the UL-DL configuration of the P-cell as the scheduling cell is “1”, and the UL-DL configuration of the S-cell as the scheduled cell is “4”.

The downlink subframe 0 of the P-cell schedules the PDSCH signal of the subframe 0 of the S-cell. The special subframe 1 of the P-cell schedules the PDSCH signal of the subframe 1 of the S-cell. The downlink subframes 4 and 9 of the P-cell schedule the PDSCH signals of both of the subframes 4 and 9 of the S-cell. The downlink subframe 5 of the P-cell schedules the PDSCH signals of both of the subframes 5 and 6 of the S-cell. The special subframe 6 of the P-cell schedules the PDSCH signals of both of the subframes 7 and 8 of the S-cell.

In the example of FIG. 27B, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configurations of FIG. 20, four CIF bit patterns can indicate all of the candidates for combinations of CCs and subframes which transmit PDSCH signals.

FIG. 28A illustrates the case where there are one each of a scheduling cell and a scheduled cell, the UL-DL configuration of the P-cell as the scheduling cell is “1”, and the UL-DL configuration of the S-cell as the scheduled cell is “5”.

The downlink subframe 0 of the P-cell schedules the PDSCH signal of the subframe 0 of the S-cell. The special subframe 1 of the P-cell schedules the PDSCH signals of the subframes 1 and 3 of the S-cell. The downlink subframes 4 and 9 of the P-cell schedule the PDSCH signals of both of the subframes 4 and 9 of the S-cell. The downlink subframe 5 of the P-cell schedules the PDSCH signal of both of the subframes 5 and 6 of the S-cell. The special subframe 6 of the P-cell schedules the PDSCH signals of both of the subframes 7 and 8 of the S-cell.

In the example of FIG. 28B, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configuration of FIG. 20, four CIF bit patterns can indicate all of the candidates for combinations of CCs and subframes which transmit PDSCH signals.

FIG. 28B illustrates the case where there are one each of a scheduling cell and a scheduled cell, the UL-DL configuration of the P-cell as the scheduling cell is “3”, and the UL-DL configuration of the S-cell as the scheduled cell is “2”.

The downlink subframe 0 of the P-cell schedules the PDSCH signal of both of the subframe 0 and 1 of the S-cell. The special subframe 1 of the P-cell schedules the PDSCH signals of both of the subframes 3 and 4 of the S-cell. The downlink subframes 5, 6, 8, and 9 of the P-cell schedule the PDSCH signals of the subframes 5, 6, 8, and 9 of the S-cell.

In the example of FIG. 28B, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configuration of FIG. 20, four CIF bit patterns can indicate all of the candidates for combinations of CCs and subframes which transmit PDSCH signals.

FIG. 29A illustrates the case where there are one each of a scheduling cell and a scheduled cell, the UL-DL configuration of the P-cell as the scheduling cell is “3”, and the UL-DL configuration of the S-cell as the scheduled cell is “5”.

The downlink subframe 0 of the P-cell schedules the PDSCH signals of both of the subframe 0 and 1 of the S-cell. The special subframe 1 of the P-cell schedules the PDSCH signals of both of the subframes 3 and 4 of the S-cell. The downlink subframes 5 to 9 of the P-cell schedule the PDSCH signals of the subframes 5 to 9 of the S-cell.

In the example of FIG. 29A, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configuration of FIG. 20, four CIF bit patterns can indicate all of the candidates for combinations of CCs and subframes which transmit PDSCH signals.

FIG. 29B illustrates the case where there are one each of a scheduling cell and a scheduled cell, the UL-DL configuration of the P-cell as the scheduling cell is “6”, and the UL-DL configuration of the S-cell as the scheduled cell is “2”.

The downlink subframe 0 of the P-cell schedules PDSCH signals of both of the subframe 0 and 1 of the S-cell. The special subframe 1 of the P-cell schedules PDSCH signals of both of the subframes 3 and 4 of the S-cell. The downlink subframes 5 and 9 of the P-cell schedule PDSCH signals of the subframes 5 and 9 of the S-cell. The special subframe 6 of the P-cell schedules PDSCH signals of both of the subframes 6 and 7 of the S-cell.

In the example of FIG. 29B, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configuration of FIG. 20, four CIF bit patterns can indicate all of the candidates for combinations of CCs and subframes which transmit PDSCH signals.

FIG. 30A illustrates the case where there are one each of a scheduling cell and a scheduled cell, the UL-DL configuration of the P-cell as the scheduling cell is “6”, and the UL-DL configuration of the S-cell as the scheduled cell is “3”.

The downlink subframe 0 of the P-cell schedules the PDSCH signal of the subframe 0 of the S-cell. The special subframe 1 of the P-cell schedules the PDSCH signal of the subframe 1 of the S-cell. The downlink subframe 5 of the P-cell schedules the PDSCH signals of both of the subframes 5 and 6 of the S-cell. The special subframe 6 of the P-cell schedules the PDSCH signals of both of the subframes 7 and 8 of the S-cell. The downlink subframe 9 of the P-cell schedules the PDSCH signal of the subframe 9 of the S-cell.

In the example of FIG. 30A, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configuration of FIG. 20, four CIF bit patterns can indicate all of the candidates for combinations of CCs and subframes which transmit PDSCH signals.

FIG. 30B illustrates the case where there are one each of a scheduling cell and a scheduled cell, the UL-DL configuration of the P-cell as the scheduling cell is “6”, and the UL-DL configuration of the S-cell as the scheduled cell is “4”.

The downlink subframe 0 of the P-cell schedules the PDSCH signal of the subframe 0 of the S-cell. The special subframe 1 of the P-cell schedules the PDSCH signals of both of the subframes 1 and 4 of the S-cell. The downlink subframe 5 of the P-cell schedules the PDSCH signals of both of the subframes 5 and 6 of the S-cell. The special subframe 6 of the P-cell schedules the PDSCH signals of both of the subframes 7 and 8 of the S-cell. The downlink subframe 9 of the P-cell schedules the PDSCH signal of the subframe 9 of the S-cell.

In the example of FIG. 30B, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configuration of FIG. 20, four CIF bit patterns can indicate all of the candidates for combinations of CCs and subframes which transmit PDSCH signals.

FIG. 31 illustrates the case where there are one each of a scheduling cell and a scheduled cell, the UL-DL configuration of the P-cell as the scheduling cell is “6”, and the UL-DL configuration of the S-cell as the scheduled cell is “5”.

The downlink subframe 0 of the P-cell schedules the PDSCH signals of both of the subframes 0 and 1 of the S-cell. The special subframe 1 of the P-cell schedules the PDSCH signals of both of the subframes 3 and 4 of the S-cell. The downlink subframe 5 of the P-cell schedules the PDSCH signals of both of the subframes 5 and 6 of the S-cell. The special subframe 6 of the P-cell schedules the PDSCH signals of both of the subframes 7 and 8 of the S-cell. The downlink subframe 9 of the P-cell schedules the PDSCH signal of the subframe 9 of the S-cell.

In the example of FIG. 31, in the same way as the example of FIG. 20, there is only one S-cell of a UL-DL configuration different from the P-cell as a scheduled cell. There are a maximum two subframes of the S-cell which one subframe of the P-cell schedules. Therefore, in the same way as the UL-DL configuration of FIG. 20, four CIF bit patterns can indicate all of the candidates for combinations of CCs and subframes which transmit PDSCH signals.

In this way, according to this embodiment, by increasing the number of subframes which are used for cross subframe scheduling etc., it is possible to keep a few subframes from being concentratedly used for cross subframe scheduling etc. As a result, even if the number of the CCs which are aggregated or the subframes which are scheduled by cross subframe scheduling increase, the limitation on combinations of CCs and subframes becomes smaller.

### 3. Third Embodiment

Next, a third embodiment of jointly coding subframe information with downlink control information will be explained. In the present embodiment, the HARQ process number, which indicates the process in the HARQ at the downlink, and the subframe information are combined. For example, when operating by TDD in LTE-Advanced, 4 bits are allocated for the HARQ process number field, which indicates the HARQ process number, and 16 bit patterns can be obtained.

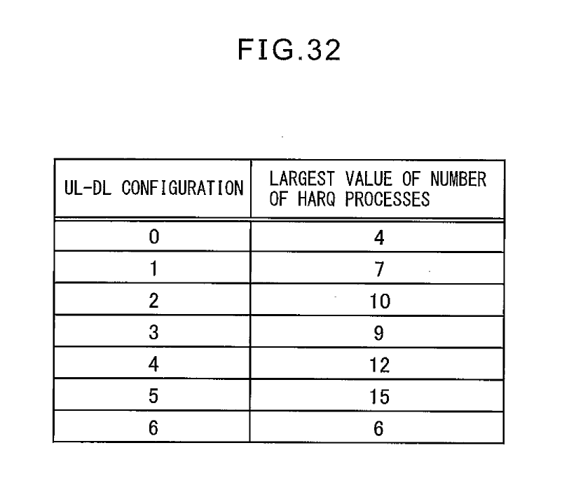

The largest number of the number of HARQ processes differs depending on the UL-DL configuration and is indicated as in FIG. 32. For example, when the UL-DL configuration of a scheduled cell is “3”, the largest number of the number of HARQ processes is 9, and thus the 16 bit patterns cannot all be used. For this reason, the remaining bit patterns of the HARQ process number fields can be used to notify subframe information by PDCCH signals. In the following explanation, “HARQ process number fields” will be abbreviated as “HARQ fields”.

3.1. Case where UL-DL Configuration of Scheduled Cell is “0”

Below, we will study the example of allocation information by which numbers of subframes, by which PDSCH signals are transmitted, are allocated for values of HARQ fields in different UL-DL configurations of a scheduled cell. As illustrated in FIG. 2, when the UL-DL configuration of a scheduled cell is “0”, the only subframes by which downlink transmission is possible are 0, 1, 5, and 6. No matter what UL-DL configuration the UL-DL configuration of the scheduling cell is, the subframes 0, 1, 5, and 6 can be used for downlink transmission, so the PDCCH signal and PDSCH signal can be transmitted by the same subframes. For this reason, there is no need for cross subframe scheduling etc.

3.2. Case where UL-DL Configuration of Scheduled Cell is “1”

When the UL-DL configuration is “1”, the largest number of the number of HARQ processes is “7”. Further, when the UL-DL configuration of the scheduling cell is “0”, the subframes 4 and 9 are allocated to the downlink at the scheduled cell and are allocated to the uplink at the scheduling cell. When the UL-DL configuration of the scheduling cell is “3” or “6”, the subframe 4 is allocated to the downlink at the scheduled cell and is allocated to the uplink at the scheduling cell. For this reason, when the UL-DL configuration of the scheduling cell is “0”, “3”, or “6”, cross subframe scheduling etc. are performed.

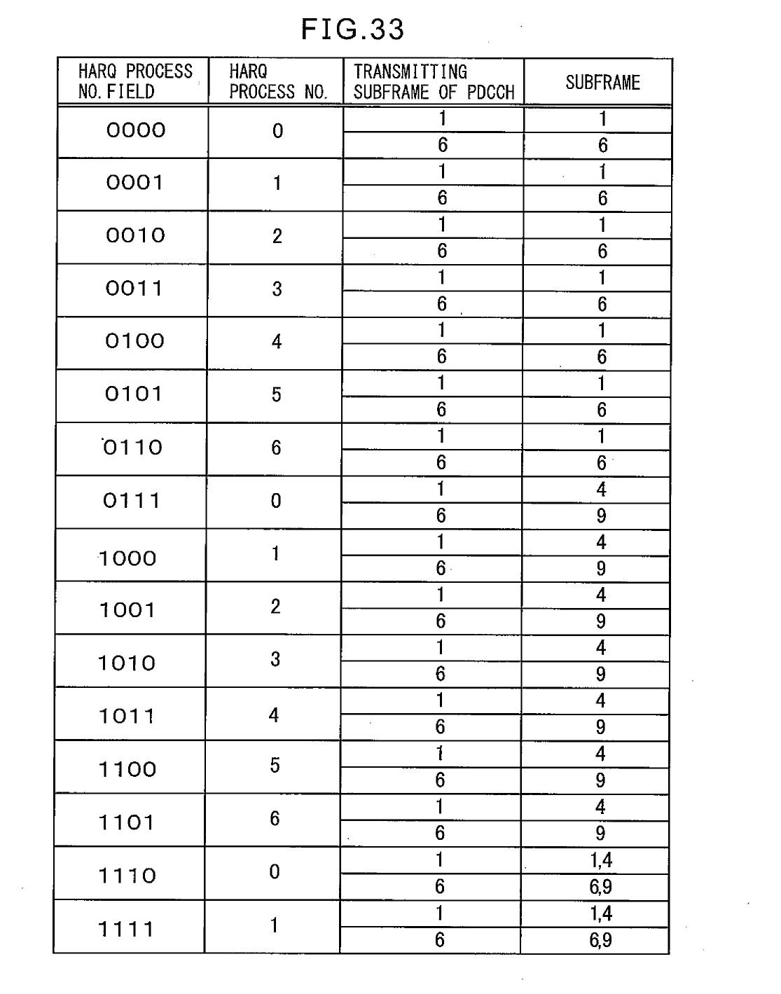

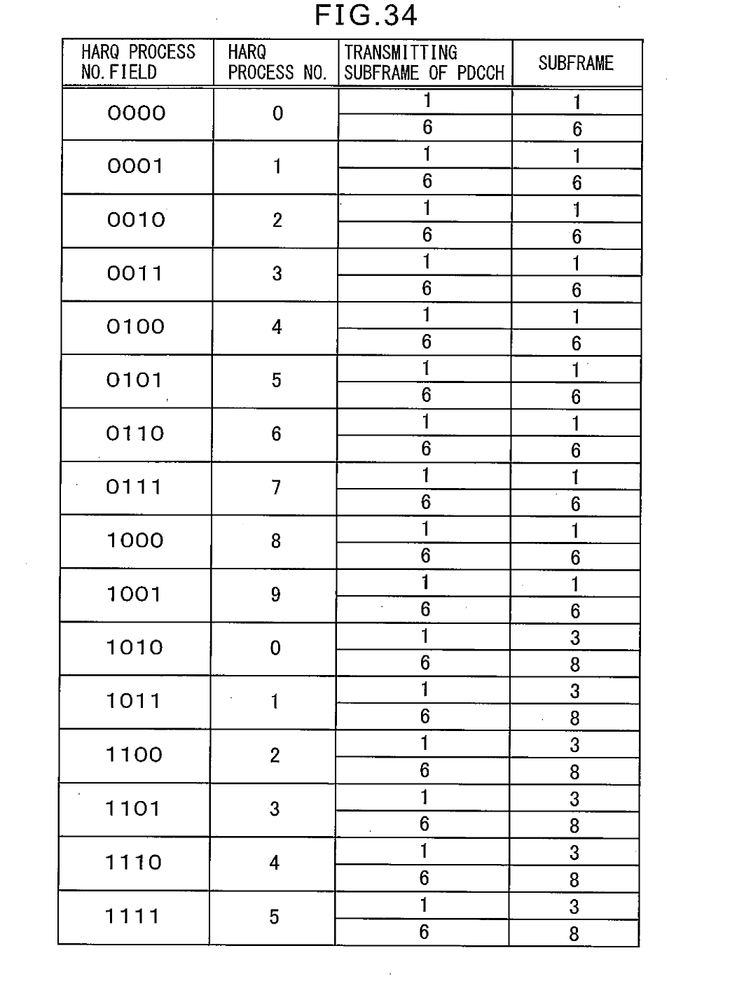

FIG. 33 is a view which explains one example of allocation information when the UL-DL configurations of the scheduled cell and scheduling cell are respectively “0” and “1”. The HARQ fields “0000” to “0110” indicate that the HARQ process numbers are respectively “0” to “6”. When using a PDCCH signal, which is transmitted by the subframe 1 of the scheduling cell, to indicate the transmitting subframe of the PDSCH signal, the HARQ fields “0000” to “0110” indicate that a PDSCH signal is transmitted by the subframe 1 of the scheduled cell. When using a PDCCH signal, which is transmitted by the subframe 6 of the scheduling cell, to indicate the transmitting subframe of the PDSCH signal, the HARQ fields “0000” to “0110” indicate that a PDSCH signal is transmitted by the subframe 6 of the scheduled cell.

The HARQ field “0111” to “1101” indicate that the HARQ process numbers are respectively “0” to “6”. When using a PDCCH signal, which is transmitted by the subframe 1 of the scheduling cell, to indicate the transmitting subframe of the PDSCH signal, the HARQ fields “0111” to “1101” indicate that a PDSCH signal is transmitted by the subframe 4 of the scheduled cell. When using a PDCCH signal, which is transmitted by the subframe 6 of the scheduling cell, to indicate the transmitting subframe of the PDSCH signal, the HARQ fields “0111” to “1101” indicate that a PDSCH signal is transmitted by the subframe 9 of the scheduled cell.

The HARQ fields “1110”, and “1111” indicate that the HARQ process numbers are respectively “0” and “1”. When using a PDCCH signal, which is transmitted by the subframe 1 of the scheduling cell, to indicate the transmitting subframe of the PDSCH signal, the HARQ fields “1110” and “1111” indicate that PDSCH signals are transmitted by both of the subframes 1 and 4 of the scheduled cell. When using a PDCCH signal, which is transmitted by the subframe 6 of the scheduling cell, to indicate the transmitting subframe of the PDSCH signal, the HARQ fields “1110” and “1111” indicate that PDSCH signals are transmitted by both of the subframes 6 and 9 of the scheduled cell.

In the above way, the combinable HARQ process numbers and subframes are partially limited, but the subframe information can be jointly coded with the HARQ process numbers and transmitted by PDCCH signals.

3.3. Case where UL-DL Configuration of Scheduled Cell is “2”

When the UL-DL configuration is “2”, the largest number of the number of HARQ processes is “10”. Further, when the UL-DL configuration of the scheduling cell is “0”, the subframes 3, 4, 8, and 9 are allocated to the downlink at the scheduled cell and are allocated to the uplink at the scheduling cell. When the UL-DL configuration of the scheduling cell is “1”, the subframes 3 and 8 are allocated to the downlink at the scheduled cell and are allocated to the uplink at the scheduling cell.

When the UL-DL configuration of the scheduling cell is “3”, the subframes 3 and 4 are allocated to the downlink at the scheduled cell and are allocated to the uplink at the scheduling cell. When the UL-DL configuration of the scheduling cell is “4”, the subframe 3 is allocated to the downlink at the scheduled cell and is allocated to the uplink at the scheduling cell. When the UL-DL configuration of the scheduling cell is “6”, the subframes 3, 4, and 8 are allocated to the downlink at the scheduled cell and are allocated to the uplink at the scheduling cell. For this reason, when the UL-DL configuration of the scheduling cell is “0”, “1”, “3”, “4”, or “6”, cross subframe scheduling etc. is performed.

FIG. 34 is a view which explains one example of allocation information which can be used when the UL-DL configuration of the scheduling cell is any of “0”, “1”, and “6”. The HARQ fields “0000” to “1001” respectively indicate that the HARQ process numbers are “0” to “9”. When using a PDCCH signal, which is transmitted by the subframe 1 of the scheduling cell, to indicate the transmitting subframe of the PDSCH signal, the HARQ fields “0000” to “1001” indicate that the PDSCH signal is transmitted by the subframe 1 of the scheduled cell. When using a PDCCH signal, which is transmitted by the subframe 6 of the scheduling cell, to indicate the transmitting subframe of the PDSCH signal, the HARQ fields “0000” to “1001” indicate that the PDSCH signal is transmitted by the subframe 6 of the scheduled cell.

The HARQ fields “1010” to “1111” indicate that the HARQ process numbers are respectively “0” to “5”. When using a PDCCH signal, which is transmitted by the subframe 1 of the scheduling cell, to indicate the transmitting subframe of the PDSCH signal, the HARQ fields “1010” to “1111” indicate that the PDSCH signal is transmitted by the subframe 3 of the scheduled cell. When using a PDCCH signal, which is transmitted by the subframe 6 of the scheduling cell, to indicate the transmitting subframe of the PDSCH signal, the HARQ fields “1010” to “1111” indicate that the PDSCH signal is transmitted by the subframe 8 of the scheduled cell. In another embodiment, the HARQ fields “1010” to “1111” may be allocated subframes for use for multiple subframe scheduling.

In the above way, it is possible to jointly code the subframes which are used for cross subframe scheduling etc. with part of the HARQ process numbers.

3.4. Case where UL-DL Configuration of Scheduled Cell is “3”

When the UL-DL configuration is “3”, the largest number of the number of HARQ processes is “9”. Further, when the UL-DL configuration of the scheduling cell is “0”, the subframes 7 to 9 are allocated to the downlink at the scheduled cell and are allocated to the uplink at the scheduling cell. When the UL-DL configuration of the scheduling cell is “1” and “6”, the subframes 7 and 8 are allocated to the downlink at the scheduled cell and are allocated to the uplink at the scheduling cell. When the UL-DL configuration of the scheduling cell is “2”, the subframe 7 is allocated to the downlink at the scheduled cell and is allocated to the uplink at the scheduling cell. For this reason, when the UL-DL configuration of the scheduling cell is “0”, “1”, “2”, or “6”, cross subframe scheduling etc. are performed.

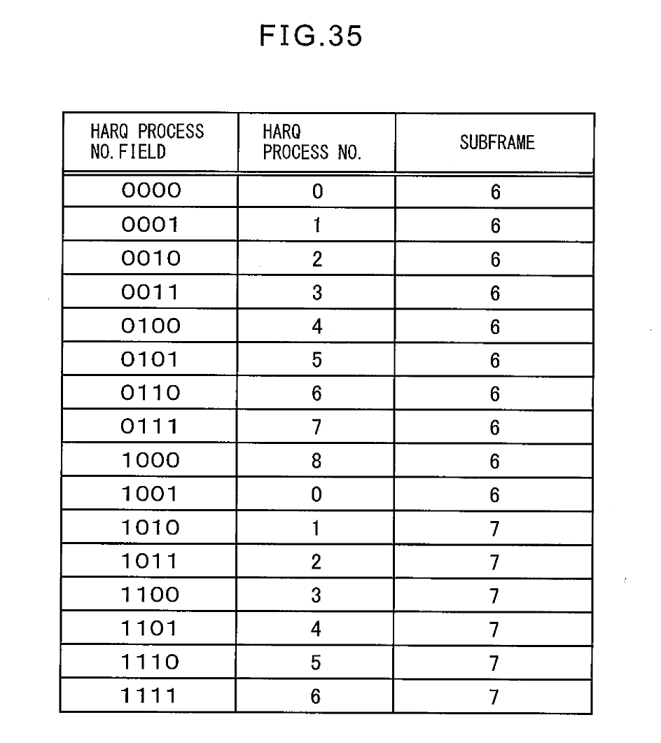

FIG. 35 is a view which explains one example of allocation information in the case of possible use even when the UL-DL configuration of the scheduling cell is any of “0”, “1”, “2”, and “6”. The HARQ fields “0000” to “1000” indicate that the HARQ process numbers are respectively “0” to “8”. When using a PDCCH signal, which is transmitted by the subframe 6 of the scheduling cell, to indicate the transmitting subframe of the PDSCH signal, the HARQ fields “0000” to “1000” indicate that the PDSCH signal is transmitted by the subframe 6 of the scheduled cell.

The HARQ fields “1001” to “1111” indicate that the HARQ process numbers are respectively “0” to “6”. When using a PDCCH signal, which is transmitted by the subframe 6 of the scheduling cell, to indicate the transmitting subframe of the PDSCH signal, the HARQ fields “1001” to “1111” indicate that the PDSCH signal is transmitted by the subframe 7 of the scheduled cell. In another embodiment, the subframes, which are used for multiple subframe scheduling, may be allocated to the HARQ fields “1001” to “1111”.

In the above way, it is possible to jointly code the subframe, which is used for cross subframe scheduling etc., with part of the HARQ process numbers.

3.5. Case where UL-DL Configuration of Scheduled Cell is “4”

When the UL-DL configuration is “4”, the largest number of the number of HARQ processes is “12”. Further, when the UL-DL configuration of the scheduling cell is “0”, the subframes 4 and 7 to 9 are allocated to the downlink at the scheduled cell and are allocated to the uplink at the scheduling cell. When the UL-DL configuration of the scheduling cell is “1”, the subframes 7 and 8 are allocated to the downlink at the scheduled cell and are allocated to the uplink at the scheduling cell.

When the UL-DL configuration of the scheduling cell is “2”, the subframe 7 is allocated to the downlink at the scheduled cell and is allocated to the uplink at the scheduling cell. When the UL-DL configuration of the scheduling cell is “3”, the subframe 4 is allocated to the downlink at the scheduled cell and is allocated to the uplink at the scheduling cell.

When the UL-DL configuration of the scheduling cell is “6”, the subframes 4, 7, and 8 are allocated to the downlink at the scheduled cell and are allocated to the uplink at the scheduling cell. For this reason, when the UL-DL configuration of the scheduling cell is “0”, “1”, “2”, “3”, or “6”, cross subframe scheduling etc. are performed.

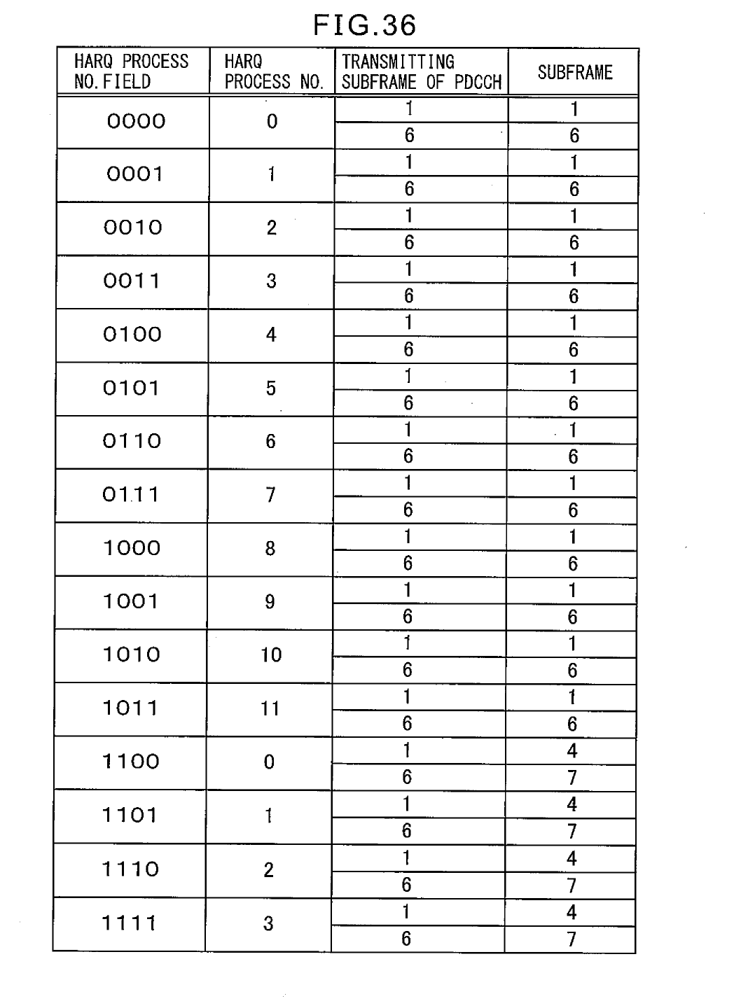

FIG. 36 is a view which explains one example of allocation information which can be used when the UL-DL configuration of the scheduling cell is any of “0” and “6”. The HARQ fields “0000” to “1011” indicate that the HARQ process numbers are “0” to “11”. When using a PDCCH signal, which is transmitted by the subframe 1 of the scheduling cell, to indicate the transmitting subframe of the PDSCH signal, the HARQ fields “0000” to “1011” indicate that the PDSCH signal is transmitted by the subframe 1 of the scheduled cell. When using a PDCCH signal, which is transmitted by the subframe 6 of the scheduling cell, to indicate the transmitting subframe of the PDSCH signal, the HARQ fields “0000” to “1011” indicate that the PDSCH signal is transmitted by the subframe 6 of the scheduled cell.

The HARQ fields “1100” to “1111” indicate that the HARQ process numbers are respectively “0” to “3”. When using a PDCCH signal, which is transmitted by the subframe 1 of the scheduling cell, to indicate the transmitting subframe of the PDSCH signal, the HARQ fields “1100” to “1111” indicate that the PDSCH signal is transmitted by the subframe 4 of the scheduled cell. When using a PDCCH signal, which is transmitted by the subframe 6 of the scheduling cell, to indicate the transmitting subframe of the PDSCH signal, the HARQ fields “1100” to “1111” indicate that the PDSCH signal is transmitted by the subframe 7 of the scheduled cell. In another embodiment, it is possible to allocate subframes, which are used for multiple subframe scheduling, to the HARQ fields “1100” to “1111”.

As explained above, for some HARQ process numbers, joint coding with the subframes, which are used for cross subframe scheduling etc., is possible.

3.6. Case where UL-DL Configuration of Scheduled Cell is “5”

When the UL-DL configuration is “5”, the largest number of the number of HARQ processes is “15”. Further, when the UL-DL configuration of the scheduling cell is “0”, the subframes 3, 4, and 7 to 9 are allocated to the downlink at the scheduled cell and are allocated to the uplink at the scheduling cell. When the UL-DL configuration of the scheduling cell is “1”, the subframes 3, 7, and 8 are allocated to the downlink at the scheduled cell and are allocated to the uplink at the scheduling cell.

When the UL-DL configuration of the scheduling cell is “2”, the subframe 7 is allocated to the downlink at the scheduled cell and is allocated to the uplink at the scheduling cell. When the UL-DL configuration of the scheduling cell is “3”, the subframes 3 and 4 are allocated to the downlink at the scheduled cell and are allocated to the uplink at the scheduling cell.

When the UL-DL configuration of the scheduling cell is “4”, the subframe 3 is allocated to the downlink at the scheduled cell and is allocated to the uplink at the scheduling cell. When the UL-DL configuration of the scheduling cell is “6”, the subframes 3, 4, 7, and 8 are allocated to the downlink at the scheduled cell and are allocated to the uplink at the scheduling cell. For this reason, when the UL-DL configuration of the scheduling cell is “0”, “1”, “2”, “3”, “4”, or “6”, cross subframe scheduling etc. are performed.

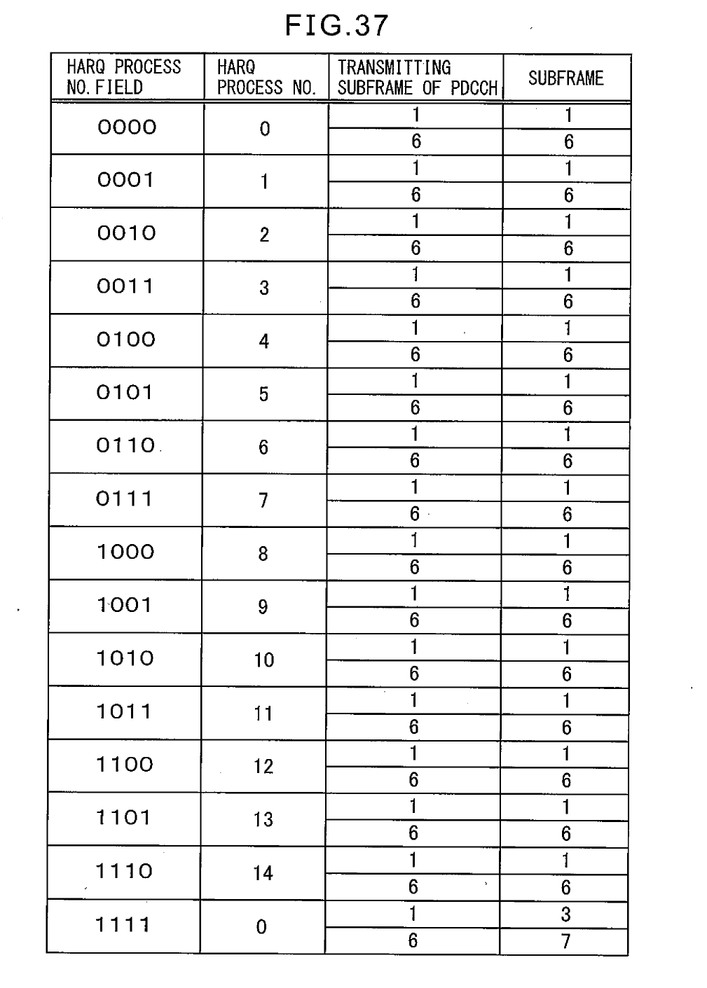

FIG. 37 is a view which explains one example of allocation information which can be used when the UL-DL configuration of the scheduling cell is any of “0”, “1”, and “6”. The HARQ fields “0000” to “1110” indicate that the HARQ process numbers are respectively “0” to “14”. When using a PDCCH signal, which is transmitted by the subframe 1 of the scheduling cell, to indicate the transmitting subframe of the PDSCH signal, the HARQ fields “0000” to “1110” indicate that PDSCH signals are transmitted by the subframe 1 of the scheduled cell. When using a PDCCH signal, which is transmitted by the subframe 6 of the scheduling cell, to indicate the transmitting subframe of the PDSCH signal, the HARQ fields “0000” to “1110” indicate that PDSCH signals are transmitted by the subframe 6 of the scheduled cell.

The HARQ field “1111” illustrates when the HARQ process number is “0”. When using a PDCCH signal, which is transmitted by the subframe 1 of the scheduling cell, to indicate the transmitting subframe of the PDSCH signal, the HARQ field “1111” indicates that a PDSCH signal is transmitted by the subframe 3 of the scheduled cell. When using a PDCCH signal, which is transmitted by the subframe 6 of the scheduling cell, to indicate the transmitting subframe of the PDSCH signal, the HARQ field “1111” indicates that a PDSCH signal is transmitted by the subframe 7 of the scheduled cell. In another embodiment, the HARQ field “1111” may be allocated the subframes which are used for multiple subframe scheduling.

When the UL-DL configuration of the scheduled cell is “5”, it is possible to jointly code the subframe, which is used for subframe scheduling etc., with only a single HARQ process number.

3.7. Case where UL-DL Configuration of Scheduled Cell is “6”

When the UL-DL configuration is “6”, the largest number of the number of HARQ processes is “6”. Further, when the UL-DL configuration of the scheduling cell is “0”, the subframe 9 is allocated to the downlink at the scheduled cell and is allocated to the uplink at the scheduling cell. For this reason, when the UL-DL configuration of the scheduling cell is “0”, cross subframe scheduling etc. are performed.

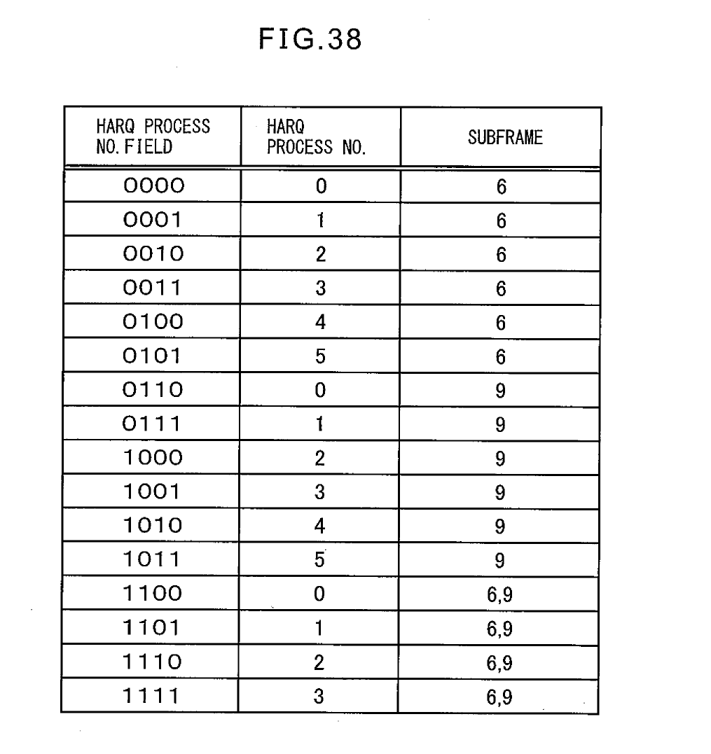

FIG. 38 is a view which explains one example of allocation information when the UL-DL configuration of the scheduling cell is “0”. The HARQ fields “0000” to “0101” respectively indicate HARQ process numbers of “0” to “5”. When using a PDCCH signal, which is transmitted by the subframe 6 of the scheduling cell, to indicate a transmission subframe of the PDSCH signal, the HARQ fields “0000” to “0101” indicate that PDSCH signals are sent by the subframe 6 of the scheduled cell.

The HARQ fields “0110” to “1011” indicate the HARQ process numbers of “0” to “5”. When using a PDCCH signal, which is transmitted by the subframe 6 of the scheduling cell, to indicate the transmission subframe of the PDSCH signal, the HARQ fields “0110” to “1011” indicate that PDSCH signals are sent by the subframe 9 of the scheduled cell.

The HARQ fields “1100” to “1111” illustrate that the HARQ process numbers are respectively “0” to “3”. When using a PDCCH signal, which is transmitted by the subframe 6 of the scheduling cell, to indicate the transmission subframe of the PDSCH signal, the HARQ fields “1100” to “1111” indicate that PDSCH signals are sent by both the subframes 6 and 9 of the scheduled cell.

In the above way, the combinable HARQ process numbers and subframes are partially limited, but the subframe information may be jointly coded with the HARQ process number and transmitted by the PDCCH signal.

3.8. Advantageous Effects

According to the present embodiment, the subframe information is jointly coded with the HARQ process numbers where not all of the bit patterns of the HARQ process number fields are used up. Due to this, it is possible to use the remainder of the bit patterns of the HARQ process number fields to notify the subframes which are used for cross subframe scheduling etc. For this reason, the increase in downlink control information for cross subframe scheduling etc. when the scheduling cell and the scheduled cell differ, is lessened.

### 4. Hardware Configurations

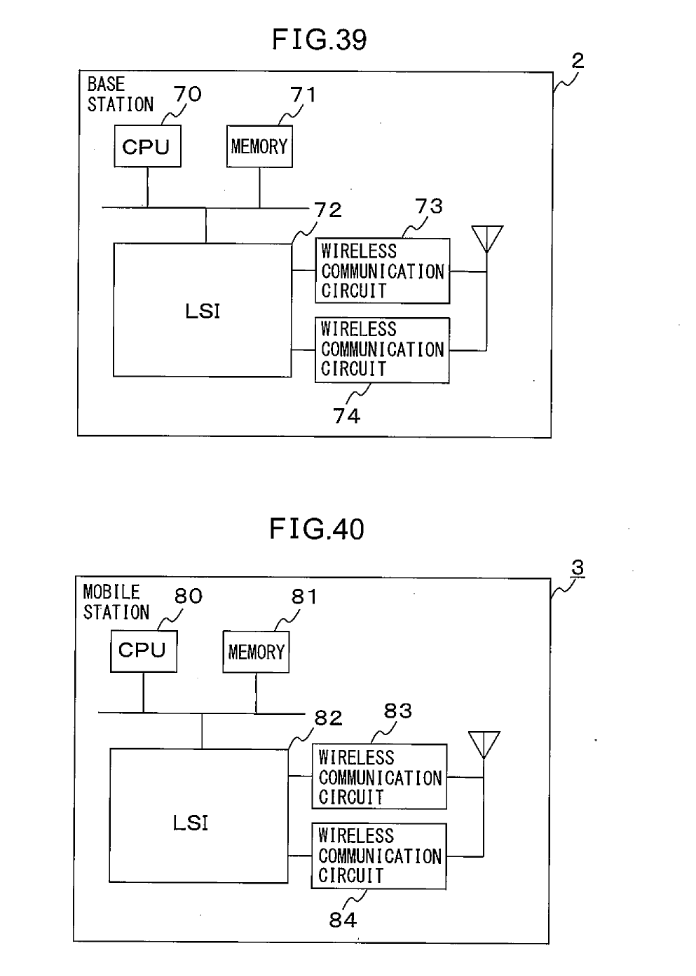

Finally, one example of the hardware configurations for realizing the base station 2 and the mobile station 3 will be explained. FIG. 39 is a view which explains one example of the hardware configuration of the base station 2. The base station 2 is provided with a CPU (Central Processing Unit) 70, memory 71, LSI (Large Scale Integrated circuit) 72, and wireless communication circuits 73 and 74. The memory 71 may also include a memory for storing computer programs or data such as a nonvolatile memory, read only memory (ROM), random access memory (RAM), etc. The LSI (Large Scale Integrated circuit) 72 may also include a FPGA (Field Programmable Gate Array), ASIC (Application Specific Integrated Circuit), DSP (Digital Signal Processor), etc. The wireless communication circuit 73 may also include a digital-analog conversion circuit, a frequency conversion circuit, etc. The wireless communication circuit 74 may also include an analog-digital conversion circuit, a frequency conversion circuit etc.

The above operations of the wireless processing unit 18 and wireless processing unit 20 of the base station 2 which are shown in FIG. 4 are, for example, performed by the wireless communication circuits 73 and 74. The above operations of the scheduler 10, L1/L2 control information generation unit 11, control channel generation unit 12, MAC control information generation unit 13, RRC control information generation unit 14, and user data generation unit 15 are performed by the CPU 70 cooperating with LSI 72. The above operations of the shared channel generation unit 16, multiplexing unit 17, demultiplexing unit 21, uplink data processing unit 22, and allocation information generation unit 30 are performed by the CPU 70 cooperating with LSI 72.

FIG. 40 is a view which explains one example of the hardware configuration of the mobile station 3. The mobile station 3 is provided with a CPU 80, memory 81, LSI 82, and wireless communication circuits 83 and 84. The memory 81 may contain a memory for storing computer programs or data such as a nonvolatile memory, read only memory, random access memory, etc. The LSI 82 may contain an FPGA, ASIC, DSP, etc. The wireless communication circuit 83 may contain an analog-digital conversion circuit, frequency conversion circuit, etc. The wireless communication circuit 84 may contain a digital-analog conversion circuit, frequency conversion circuit, etc.

The above operations of the wireless processing unit 40 and wireless processing unit 53 of FIG. 7 are, for example, performed by the wireless communication circuits 83 and 84. The above operations of the demultiplexing unit 41, control channel processing unit 42, shared channel processing unit 43, demultiplexing unit 44, allocation information storage unit 45, and user data processing unit 46 are performed by the CPU 80 cooperating with LSI 82. The above operations of the user data generation unit 50, shared channel generation unit 51, and multiplexing unit 52 are performed by the CPU 80 cooperating with LSI 82.

Note that, the hardware configurations which are illustrated in FIG. 39 and FIG. 40 are only examples for explaining the embodiments. So long as performing the operations which are described above, any hardware configurations may be employed for the base station 2 and the mobile station 3 which are described in this specification. Further, the views of the functional configuration of FIG. 4 and FIG. 7 primarily show configurations relating to the functions of the base station 2 and the mobile station 3 which are explained in this specification. The base station 2 and the mobile station 3 may include components other than the illustrated components. The series of operations which are explained referring to FIG. 8 and FIG. 9 may be interpreted as a method including a plurality of routines. In this case, “operation” may be read as “step”.

All examples and conditional language recited hereinafter are intended for pedagogical purposes to aid the reader in understanding the principles of the invention and the concepts contributed by the inventor to furthering the art and are to be construed as being without limitation to such specifically recited examples and conditions. Nor does the organization of such examples in the specification relate to a showing of the superiority and inferiority of the invention. Although the embodiments of the present inventions have been described in detail, it should be understood that various changes, substitutions, and alterations could be made hereto without departing from the spirit and scope of the invention.

### REFERENCE SIGNS LIST

1 communication system
2 base station apparatus
3 mobile station apparatus
10 scheduler
11 L1/L2 control information generation unit
12 control channel generation unit
13 MAC control information generation unit
14 RRC control information generation unit
16 shared channel generation unit
30 allocation information generation unit

What is claimed is:

1. A communication apparatus comprising:
a processor configured to select a subframe for transmitting a signal to a first communication apparatus from a second communication apparatus by a first carrier, as a subframe for transmitting data from the first communication apparatus to the second communication apparatus by a second carrier, from among a plurality of subframes which form wireless frames and are respectively allocated in any transmission directions of time-division duplex;
a receiver configured to jointly code indication information for indicating the subframe, selected by the processor, with control information transmitted by the first carrier, to generate a code; and
a transmitter configured to transmit the code generated by the receiver to the second communication apparatus by the first carrier.

2. The communication apparatus according to claim 1, further comprising a second processor configured to select a subframe, with priority, as a subframe that transmits the code, which is closer to a subframe that transmits the data before the subframe transmitting the data, from among subframes which are allocated for transmission from the first communication apparatus to the second communication apparatus.

3. The communication apparatus according to claim 1, further comprising an allocation information generator configured to generate allocation information which allocates a subframe for transmitting data to the code according to whether each of the plurality of subframes is allocated to any of the transmission direction.

4. The communication apparatus according to claim 3, wherein the receiver uses the allocation information, as the basis, to jointly code the indication information to the control information.

5. The communication apparatus according to claim 3, further comprising an allocation information transmitter configured to transmit the allocation information to the second communication apparatus.

6. The communication apparatus according to claim 1, wherein
the control information which is jointly coded with the indication information is indication information for indicating a carrier by which data is transmitted from the first communication apparatus to the second communication apparatus,
the processor selects any carrier, as the carrier for transmitting the data, where an allocation of transmission directions for the plurality of subframes is equal to the first carrier, and
the receiver generates a code which does not change depending on a transmitting subframe of data, when using any of the carriers to transmit data.

7. The communication apparatus according to claim 2, wherein the second processor selects the following subframes as the subframes that transmit data,
a first subframe which is closest to a subframe for transmitting the data before the subframe for transmitting the data, from among subframes allocated for transmission from the first communication apparatus to the second communication apparatus, and
a second subframe which is closest to the first subframe before the first subframe, from among subframes allocated for transmission from the first communication apparatus to the second communication apparatus.

8. A communication apparatus comprising:
a receiver configured to receive a code obtained by jointly coding control information with indication information for indicating any subframe in which a signal to a first apparatus is transmitted from a second communication apparatus by a first carrier, as a subframe, which transmits the signal from the first apparatus to the second apparatus by the first carrier, from among a plurality of subframes which form wireless frames and are respectively allocated in any transmission directions of time-division duplex; and
a receiver configured to receive data transmitted from the first communication apparatus by the second carrier and by the subframes indicated by the indication information.

9. The communication apparatus according to claim 8, further comprising an allocation information receiver configured to receive, from the first communication apparatus, allocation information for allocating the subframe for transmitting the data to the code.

10. The communication apparatus according to claim 1, wherein the control information which is jointly coded with the indication information, is indication information for indicating the carrier by which the data is transmitted from the first communication apparatus to the second communication apparatus.

11. The communication apparatus according to claim 1, wherein the control information which is jointly coded with the indication information is an identifier of an automatic repeat request process of data which is transmitted from the first communication apparatus to the second communication apparatus.

12. A communication system having a first communication apparatus and a second communication apparatus,
the first communication apparatus comprising:
a processor configured to select a subframe for transmitting a signal to a first communication apparatus from a second communication apparatus by a first carrier, as a subframe for transmitting data from the first communication apparatus to the second communication apparatus by a second carrier, from among a plurality of subframes which form wireless frames and are respectively allocated in any transmission directions of time-division duplex;
a receiver configured to jointly code indication information for indicating the subframe, selected by the processor, with control information transmitted by the first carrier, to generate a code; and
a code transmitter configured to transmit the code generated by said receiver to the second communication apparatus by the first carrier.

13. A communication method comprising
selecting a subframe for transmitting a signal to a first communication apparatus from a second communication apparatus by a first carrier, as a subframe for transmitting data from the first communication apparatus to the second communication apparatus by a second carrier, from among a plurality of subframes which form wireless frames and are respectively allocated in any transmission directions of time-division duplex;
jointly coding indication information for indicating the selected subframe with control information transmitted by the first carrier, to generate a code, and
transmitting the code by the first carrier to the second communication apparatus.
